(19) United States
(12) Patent Application Publication
(10) Pub. No.: US 2018/0345178 A1
(43) Pub. Date: Dec. 6, 2018

(54) ROTARY AND LATERALLY TRANSLATING WASHER FOR FILTER PRESSES AND METHODS THEREOF

(71) Applicant: FLSmidth A/S, Valby (DK)

(72) Inventors: Thomas Morris, Spanish Fork, UT (US); Jeffrey Sharp, Salt Lake City, UT (US)

(21) Appl. No.: 15/571,275

(22) PCT Filed: May 5, 2016
(86) PCT No.: PCT/US16/31014

§ 371 Date: Nov. 2, 2017

Related U.S. Application Data
(60) Provisional application No. 62/157,386, filed on May 5, 2015.

(51) Int. Cl. B01D 25/38; B01D 25/164; B01D 25/34

(52) U.S. Cl. CPC B01D 25/386; B01D 25/346; B01D 25/164

(57) ABSTRACT

Various embodiments of a filter (31 38, 42) are disclosed. According to some embodiments, filter (31, 38, 42) may have a frame (34) and washing means operatively coupled to the frame (34) which is configured to wash one or more filter cloths simultaneously, the filter cloths being attached to a respective number of filter plate assemblies (13) which are supported by the frame (34). The washing means may comprise a laterally traversing washer mechanism, the laterally traversing washer mechanism being configured to move (8) along a lateral axis (35) of the filter (31, 38, 42) from a first side of the one or more filter cloths to a second side of the one or more filter cloths. In some embodiments, the washing means may be operatively coupled to the frame (34) via a track (3) and a washer carriage (1) on the track (3). In some embodiments, the washer carriage may be further provided with means, for example, to simultaneously shake one or more filter plate assemblies (13), without limitation. Methods of filtering slurry comprising the steps of moving (8) a laterally traversing washer mechanism in a direction along a lateral axis (35) of a filter (31, 38, 42); rotating at least one spray bar (2); and providing wash water to the at least one spray bar (2) are further disclosed.

### CROSS-REFERENCE OF RELATED APPLICATIONS

This application claims the benefit of and priority to U.S. Provisional Patent Application Ser. No. 62/157,386 filed on 5 May 2015, and titled “ROTARY AND LATERALLY TRANSLATING WASHER FOR FILTER PRESSES AND METHODS THEREOF”. This application further relates to priority document U.S. Provisional Patent Application Ser. No. 61/943,249 filed on 21 Feb. 2014, and titled “FILTER PRESS FOR HIGH PERFORMANCE LIQUID/SOLID SEPARATIONS AND METHODS THEREOF”. This application further relates to International PCT Patent Application No. PCT/US2015/017117 filed on 23 Feb. 2014, and titled “FILTER PRESS FOR HIGH PERFORMANCE LIQUID/SOLID SEPARATIONS AND METHODS THEREOF”. The aforementioned documents are hereby incorporated by reference in their entirety for any and/or all purposes as if fully set forth herein.

### FIELD OF THE INVENTION

This invention relates to filtration devices such, in particular, filter presses.

### BACKGROUND OF THE INVENTION

Typical filter presses consist of a plurality of plates for the purpose of filtering. Plates are closed and held together (closed) during a filter cycle by the use of hydraulic cylinders. The filter is opened by pulling the plates apart allowing dried cake formed from dewatered slurry to fall from the cloth. It is beneficial after dropping the cake to clean the cloth by shaking the cloth and/or by washing the cloth.

On a filter press comprising a plurality of filter plates, it is typical to provide media/cloths that hang between the filter plates for use as filtration media to collect filtered solids. The cloths are often hung by means of a cloth bar. That cloth bar typically doubles as a manifold for spray wash water for cleaning the filter cloths. Conventional cloth bars are typically suspended above the filter plate by means of a built up metal framework. The cloth bar/spray bar and associated frameworks to hold it suspended serve the purpose of both providing wash water and suspending the cloths. These prior systems can be fairly heavy and complex, thereby necessitating a better, lighter, solution. These prior systems also may not effectively wash all portions of a filter or may consume excessive plant water. There is a need to decrease weight of the entire filter, lower costs to fabricate a filter, lower the center of gravity of wash mechanisms of a filter, and/or lower costs to ship a filter and/or components thereof.

With typical horizontal filter press designs, the filter plate stack opens and drops its filtered solids (i.e., filter cake). Often thereafter, a shaker may provide motion or vibration to the filter plates; for example, in order to shake and/or detach particles, chunks of cake, or other residual solids clinging to filter cloths/filter media. Also, once a drip tray is closed, washers may be used to clean the filter cloths/filter media. Washing tends to remove residual solids particles that might damage the filter cloths/filter media, or which might prevent proper sealing between filtration cycles during open and close cycles. The shaker and the wash water manifolds, as well as other items the filter press might require, are typically mounted to the floor, the press frame, to the plates, or otherwise solidly mounted to a stationary object on the filter. This requires that these devices be at, or nearly the full operating length of the filter, in order to provide their intended purposeful functions to each and every one of the filter plates in the filter press plate stack.

In order to reduce the size envelope, cost, and/or complexity of a filter press, a simple, reliable, and efficient filter press wash structure (e.g., one which may be ideally configured to be mounted onto a carriage and track system) is needed. Accordingly, in some of the preferred embodiments disclosed, a wash structure is provided, which may comprise a shaker or shaking means to reduce cost and/or complexity. For example, in some preferred embodiments, a shaker with integral washer, a shaker/washer combination, and/or a washer (alone) may be configured to traverse down the length of the filter and provide its operation in one or more select areas within a plate stack. As may be appreciated from the disclosed figures and descriptions herein, a select number (e.g., a plurality or group) of plates within a filter plate stack may be opened, shaked, and/or washed simultaneously, but independently of other plates within the filter plate stack.

As previously stated, it is common practice to wash filtered solids off of filter media in order to improve cloth life and/or to improve sealing between filter surfaces. Washing may help to ensure that filter cloths are relatively free of large buildups of filtered solids/filter cake. Flood wash systems usually comprise a floor-mounted manifold with nozzles and/or manifolds as part of the cloth hanging hardware (e.g., onboard wash structure provided to each filter plate assembly). Accordingly, components of prior flood wash systems move with the filter plates. Excessive movement of the nozzles during shaking operations may lead to nozzle breakage, clogging, spray misalignment, etc. Moreover, water weight and/or component weight attributed to the nozzles and/or manifolds provided on the plate assemblies may cause imbalances, plate assembly top-heaviness, or higher OPEX costs to maintain. Additionally, such prior flood wash systems often have a high number of separate hoses which are necessary for allowing travel of the plates and/or which can hang up on other moving parts of the filter.

There also exists a need to low-pressure wash (e.g., flood wash) and/or direct high-pressure wash multiple cloths at once. The inventors have developed a positioning rotary and/or laterally translating manifold design which is preferably capable of washing one or more appropriate plates and respective filter cloths. The design may incorporate a traveling washer system not yet seen with prior filter devices—in particular filter presses. In preferred embodiments, as shown, the lateral translation may comprise a horizontal movement, from a left or right hand side of a filter to the other of said left or right hand side of a filter (or from a front side of a filter to the rear side to the filter), wherein rotation of a manifold or components thereof may occur via a swivel joint. Center of gravity is lowered, overall weight and complexity is reduced, and the machine may be configured to be run more efficiently. For example, “single pass wash—index carriage—single pass wash” cycles are possible, wherein the following sequence may occur, without limitation: “single pass wash to the left—index carriage—single pass wash to the right—index carriage—single pass wash to the left—index carriage single pass wash to the right”. Moreover, “double pass wash—index carriage—double pass wash” cycles are possible, wherein the following sequence may occur, without limitation: “single pass wash to the left single pass wash to the right—index carriage—single pass wash to the left—single pass wash to the right—index carriage single pass wash to the left—single pass wash to the right—index carriage—single pass wash to the left—single pass wash to the right”. Alternatively, a mirrored pattern could be employed without limitation, such as: “single pass wash to the right—single pass wash to the left index carriage—single pass wash to the right single pass wash to the left—index carriage—single pass wash to the right—single pass wash to the left index carriage single pass wash to the right single pass wash to the left”.

It is common practice to shake filtered solids off of filter media, because it helps to extend cloth life and improve sealing of filter surfaces. In other words, it is relatively important that filter cloths are relatively free of large buildup of filtered solids or filter cake. Shaker systems usually comprise a frame mounted to the floor and a mechanism that induces a motion which shakes the filter plates and cloth. However, such shaker systems are not mobile as with embodiments of a filter disclosed herein. According to certain embodiments disclosed herein, a portion of the plates that have been opened in a plate stack of a filter press may be simultaneously shaken (whether “collectively” shaken at the same time, or independently but “substantially simultaneously” shaken in quick succession). In doing so, less cost-efficient traditional shaking means comprising a shaker frame that spans the entire length of the filter may be avoided, wherein only a select few plates may be shaken at a time (this may be readily appreciated by the appended drawings). Accordingly, there is also a need for a shaker that is adapted to travel to a correct position down the length of the filter press where it may then shake the filter cloths of a select few plates that are open and which are in need of shaking the filter cloths. Embodiments disclosed herein may further overcome some of the technical challenges found in prior art filter presses regarding plates changing their “open” positions over time, for example, due to wear or stretch of linking mechanisms between the plates. It will be further appreciated (e.g., from FIG. 13), that in some embodiments which are disclosed herein, a shaking function may be simultaneously obtained by surface engagements or sliding surface contacts which are made between a component of a filter plate assembly (e.g., a cloth securement bar) and a portion of a laterally-translating washer assembly (e.g., a roller 16 provided on a rotating or laterally translating washer manifold assembly). In this regard, multiple functions (e.g., shaking and washing) may be performed with fewer components, and/or multiple functions (e.g., shaking and washing) which are typically performed in separate steps, may be performed simultaneously, thereby significantly reducing cycle times, capital expenditures (CAREX), manufacturing costs, operating expenditures (APEX), weight, complexity, etc.

Filter presses have a plurality of plates that must be separated in order for the filtered solids to drop off of the filter cloth. To date, conventional filter presses have either shifted a single filter plate (i.e., “one at a time”), or have pulled open the entire stack of plates in one single motion. A benefit of opening all plates at once is that the opening process tends to be faster than opening one single plate at a time; however, in this regard, the filter must be built very long. A benefit of opening one plate at a time is that the filter may be made shorter in overall length, thereby reducing overall footprint. However, the opening process is much slower than opening all plates at once. Accordingly, there exists an unmet need for a filter that is configured to open some, but not all of the plates in a filter plate stack at once, so that the filter may operate quickly but does not have to be built too long. For example, in some preferred embodiments disclosed, a filter may open six plates at once, thereby reducing cycle times while providing the ability to reduce filter footprint, without limitation. This disclosure outlines improvements to washer carriages such as those described in U.S. Provisional Patent Application Ser. No. 61/943,249 filed on 21 Feb. 2014, and co-pending International PCT Patent Application No. PCT/US2015/017117 filed on 23 Feb. 2014, which are hereby incorporated by reference in their entirety.

The washer carriage designs outlined in U.S. Provisional Patent Application Ser. No. 61/943,249 and International PCT Patent Application No. PCT/US2015/017117 would generally require a sufficiently large height clearance requirement, and therefore, may have potential issues with lack of overhead clearance in buildings. The prior conceived washer carriage designs disclosed in the aforementioned patent applications are tall by necessity, in order for the washer carriage designs to function. In other words, the washer carriage designs outlined in the aforementioned patent applications need to be tall enough to vertically raise spray bars up above and away from the filter plate assemblies, so that the washer carriage can safely translate horizontally along a length of the filter without interference between the filter plates and spray bars. Moreover, in the washer carriage designs outlined in U.S. Provisional Patent Application Ser. No. 61/943,249 and International PCT Patent Application No. PCT/US2015/017117, spray bars may also need to be long enough to travel from an up (i.e., top) position towards the bottom edge of a respective filter plate assembly, in order to sufficiently clean a filter cloth provided to the respective filter plate assembly. This means that for practical purposes, embodiments of the washer carriage designs outlined in U.S. Provisional Patent Application Ser. No. 61/943,249 and International PCT Patent Application No. PCT/US2015/017117 could be more than twice the height of a filter plate assembly.

To remedy this, and to enable customers having strict height considerations to employ those filtration devices, the inventors of the instant application have contemplated new designs which are much more compact, which have much lower overall height, which have much lower center of gravity, and which may experience less mechanical complications (e.g., with alignment, weight, and/or vibration) when compared to the washer carriage designs outlined in U.S. Provisional Patent Application Ser. No. 61/943,249 and International PCT Patent Application No. PCT/US2015/017117 and other prior art devices. Moreover, the newly contemplated designs disclosed herein may eliminate many complicated moving components, minimize the distance spray bars need to travel (e.g., in an up and down vertical direction), may improve reliability, may improve stability during washer carriage movement (including starts and stops) due to a much lower center of mass, may reduce fabrication, shipping, and/or assembly costs, may reduce overall weight of a washer carriage, may reduce leakage, and/or may require less structural support structures.

Accordingly, a new, simpler, lower cost, and smaller height envelope washer carriage design is needed for filter presses (e.g., as an option for customers of the FLSmidth® AFP-IV™ LC filter press for high performance liquid/solid separation, as an option for replacing a single or double S-Wash spray bar design for a more compact and a more stable washer for use with traditional FLSmidth® Shriver® sidebar filter presses, and/or as an option for replacing the L-wash single or double spray bar washer on an FLSmidth® Shriver® overhead filter, without limitation).

### OBJECTS OF THE INVENTION

It is, therefore, an object of certain embodiments of the invention, to provide an improved filter press which may reduce manufacturing and/or capital expenditure (CAPEX) costs, which may reduce the necessary footprint area for a filtration process, and/or which may increase filtration area per footprint ratio, etc.

It is also an object of certain embodiments of the invention, to improve upon existing FLSmidth® AFP IV™ filter technology by providing an AFP IV™ LC filter press which overcomes the above problems.

It is further an object of certain embodiments of the invention, to reduce operational (OPEX) costs, for example, by decreasing cycle time and/or reducing mechanical complexities.

It is a further object of certain embodiments of the invention to greatly simplify the wash mechanism for a filter press and improve the robustness thereof.

It yet another object of certain embodiments of the invention to lower the center of gravity for a cloth wash mechanism, particularly for a cloth wash mechanism provided to a movable cloth wash carriage designed to work in conjunction with a filter press.

It is yet further object of the invention to expose portions of filter cloth to spray wash up to 3 times in a single spray bar pass.

It is yet further object of the invention to expose portions of e cloth to spray wash up to 6 times in a double pass of a spray bar.

These and other objects of the invention (including those eluded to in the BACKGROUND OF THE INVENTION section of this description above), will be apparent from the drawings and description herein. Although every object of the invention is believed to be attained by at least one embodiment of the invention, there is not necessarily any one embodiment of the invention that achieves all of the objects of the invention.

### BRIEF SUMMARY OF THE INVENTION

A filter having a frame supporting a track is disclosed. The filter may comprise a horizontal filter press supporting a number of filter plate assemblies comprising filter cloths. The filter may comprise a washer carriage on the track which is configured to wash and/or shake one or more of the filter cloths simultaneously. The filter cloths may be attached to respective filter plate assemblies supported by the frame. It should be understood that where used herein, “filter cloths” may include any filter media including screens. According to some embodiments, the washer carriage may comprise washing means which may include one or more spray bars operatively connected to a manifold. The manifold may be operatively connected to a hydraulic source (e.g., water), for example, via a hose connection or fitting. A laterally traversing washer mechanism may be employed to the washer carriage, which is preferably configured to move from a first side (e.g., a first lateral side) of the one or more filter cloths to a second side (e.g., a second lateral side) of the one or more filter cloths. The laterally traversing washer mechanism may employ a number of swivel joints and/or hose connections may be provided to enable articulation of the various components of the laterally traversing washer mechanism. In some preferred embodiments, a single hose may be employed with or without one or more swivel joints, without limitation.

While not expressly shown in the figures for brevity, in some embodiments, the laterally traversing washer mechanism may be employed on filters which do not have a track or movable washer carriage, in which embodiments, the laterally traversing washer mechanism may be directly or indirectly mounted to a stationary frame of the filter, rather than to the frame of a mobile washer carriage. In further embodiments, the laterally traversing washer mechanism may be mounted to the floor adjacent the filter (i.e., “floor-mounted”), without limitation. In yet even further embodiments, the laterally traversing washer mechanism may be mounted to a washer carriage which is supported by a track which is mounted to the floor and separated from the filter or frame of the filter, without limitation.

### SUMMARY OF THE INVENTION

A filter (31, 38, 42) having a frame (34) is disclosed. The frame (34) may support a track (33), as well as a washer carriage (1) on the track (33). The washer carriage (1) may be configured to wash one or more filter cloths, simultaneously. The filter cloths may be attached to a respective number of filter plate assemblies (13). The filter plate assemblies may be supported by the frame (34). In some embodiments, a washer carriage (1) may comprise a laterally traversing washer mechanism, wherein the laterally traversing washer mechanism may be configured to move (8) along a lateral axis (35) of the filter (31, 38, 42); for example, from a first side of the one or more filter cloths to a second side of the one or more filter cloths, without limitation.

According to some embodiments, the laterally traversing washer mechanism may further comprise washing means. According to some embodiments, the washing means may be configured to wash a plurality of filter cloths simultaneously. According to some embodiments, the washing means may comprise at least one spray bar (2) which may be configured to pivot about a length axis (30) of the filter (31) via at least one swivel joint (6,22). According to some embodiments, the at least one swivel joint (6,22) may comprise a multi-axis of rotation joint. According to some embodiments, the at least one swivel joint (6,22) may comprise a hose fitting. In the embodiments disclosed, swivel joints (6,22) are adapted to contain fluid and allow wash fluid to flow therethrough.

According to some embodiments, the at least one spray bar (2) may be configured to pivot about a length axis (30) of the filter, via an actuator. According to some embodiments, the actuator may comprise a motor. According to some embodiments, the actuator may comprise a hydraulic rotary actuator. According to some embodiments, the actuator may comprise rotary means (3); wherein the rotary means (3) may comprise a single or dual rack and pinion and one or more hydraulic cylinders, without limitation. According to some embodiments, the actuator may comprise at least one pivot slide surface (20), such as a cam, roller, or bearing; wherein the at least one spray bar (2) may be configured to pivot about a length axis of the filter by virtue of gravity (i.e., the weight of the one or more spray bars (2)) and by virtue of surface contact with the at least one pivot slide surface (20), without limitation. According to some embodiments, the amount of pivot about a length axis (30) of the filter (31) may be controlled using one or more sensors (e.g., one or more limit switches, optical sensors, touch sensors, mechanical switches, or the like), without limitation. According to some embodiments, the one or more sensors may be selected from the group consisting of: limit switches, proximity switches, encoders, potentiometers, lasers, light based sensors, magnetics, differential transformers, linear variable displacement transformers (LVDT), PLC controllers, and combinations thereof, without limitation. According to some embodiments, the one or more sensors may be internally provided to the washer carriage (1). According to some embodiments, the one or more sensors may be externally provided to the washer carriage (1) or a portion of the filter (31, 38, 42), for example, a portion of the frame (34), without limitation. According to some embodiments, the one or more sensors may be independent stand-alone sensors.

According to some embodiments, a chain may facilitate movement (8) of the laterally traversing washer mechanism along a lateral axis (35) of the filter (31, 38); for example, movement (8) from a first lateral side of the one or more filter cloths to a second lateral side of the one or more filter cloths, without limitation. According to some embodiments, a rack and pinion may facilitate movement (8) of the laterally traversing washer mechanism along a lateral axis (35) of the filter (31, 38); for example, movement (8) from a first side of the one or more filter cloths to a second side of the one or more filter cloths, without limitation. According to some embodiments, a linear actuator such as a pneumatic or hydraulic may facilitate movement (8) of the laterally traversing washer mechanism along a lateral axis (35) of the filter (31, 38); for example, movement (8) from a first side of the one or more filter cloths to a second side of the one or more filter cloths, without limitation. According to some embodiments, the cylinder may comprise a long stroke cylinder. According to some embodiments, the cylinder may comprise a telescoping cylinder. According to some embodiments, the cylinder may comprise a short stroke cylinder. According to some embodiments, the travel distance of the short stroke cylinder may be compounded, for example, by a mechanical advantage mechanism. The mechanical advantage mechanism may comprise, for instance, one or more linkages or scissor mechanisms, without limitation. According to some embodiments, a driven roller may facilitate movement (8) of the laterally traversing washer mechanism along a lateral axis (35) of the filter (31, 38); for example, movement (8) from a first side of the one or more filter cloths to a second side of the one or more filter cloths, without limitation. According to some embodiments, a driven linkage may facilitate movement (8) of the laterally traversing washer mechanism along a lateral axis (35) of the filter (31, 38, 42); for example, movement (8) from a first side of the one or more filter cloths to a second side of the one or more filter cloths, without limitation. According to some embodiments, the driven linkage may comprise a slider; wherein the slider may form a portion of a variable linkage, without limitation. According to some embodiments, the driven linkage may comprise a scissor linkage which may comprise a fixed point and an actuator. According to some embodiments, the movement (8) of the laterally traversing washer mechanism along a lateral axis (35) of the filter (31, 38, 42) from a first side of the one or more filter cloths to a second side of the one or more filter cloths may be controlled using one or more limit switches. A controller may be employed and operatively connected to the one or more limit switches, without limitation. The controller may control inputs to certain components of the washer mechanism; for example, it may control current or voltage inputs to electric drive motors or to control valves necessary for linear actuator (19) operation.

According to some embodiments, a filter may further comprise first washing means. The first washing means may comprise for instance, at least one spray bar (2) which may be configured to pivot (e.g., about a length axis 30 of the filter 31, 38, 42) with at least one swivel joint (6,22), wherein the rotational direction (7) of pivot may alternate after the washer carriage (1) indexes to a different position along the length of the filter (e.g., to a different position along length axis 30). In this regard, according to some embodiments, a single pass wash may be performed, thereby reducing cycle time. The single pass wash may comprise at least one spray bar (2) being initially oriented horizontally, then rotating/pivoting in a first angular direction to a vertical orientation, then moving (8) in a first lateral direction to perform a single pass wash cycle across the width of an adjacent first filter cloth, filter plate assembly, or filtering chamber. For a second pass wash, the at least one spray bar (2) may return back to its original horizontal orientation via a second lateral direction which is opposite the first lateral direction, subsequently rotate/pivot in a second angular direction opposite from the first angular direction from a vertical orientation back to its original horizontal orientation, before indexing positions along the filter length. If only a single pass wash cycle is required, the at least one spray bar (2) may continue to rotate/pivot in the first angular direction from its vertical orientation to a new horizontal orientation which mirrors the original horizontal position before indexing its position along a length axis (30) of the filter to another axial location along the length axis (30) of the filter (31, 38, 42). The above processes may repeat a number of times, for example, alternating back and forth from side to side for different filter cloths, without limitation.

According to some embodiments, a filter may further comprise first washing means having at least one spray bar (2) which may be configured to pivot (about a length axis (30) of the filter) with at least one swivel joint (6,22), wherein the particular direction (7) of pivot may change while the washer carriage (1) maintains its position along the length of the filter (e.g., wherein the washer carriage (1) may not move along length axis 30 prior to the washing means carrying out two full left and right passes per filter cloth, filter plate assembly, or filtering chamber), without limitation. According to some embodiments, a double pass wash may be performed if wash cycle time is less important than filter cloth cleanliness between filtration cycles.

According to some embodiments, one or more swivel joints (6,22) which may be configured to pivot about a vertical axis of the filter, may facilitate the lateral movement (8) of one or more spray bars (2) from a first lateral side of the one or more filter cloths to a second lateral side of the one or more filter cloths, without limitation. According to some embodiments, the one or more swivel joints (6, 22) may comprise at least one hose fitting. According to some embodiments, a slack flexible hose (22′) which may be configured to bend, may enable lateral movement (8) of the rotary and/or lateral translating washing means (e.g., one or more spray bars 2) from a first lateral side of the one or more filter cloths to a second lateral side of the one or more filter cloths, without limitation. According to some embodiments, the flexible hose may comprise one or more swivel joints (6,22) at one or more ends of the flexible hose. According to some embodiments, a screw-drive mechanism (e.g., a worm and follower drive) may facilitate movement from a first side of the one or more filter cloths to a second side of the one or more filter cloths. According to some embodiments, rotation of the screw-drive mechanism may be controlled by one or more of the group consisting of: an encoder, limit switches, proximity switches, potentiometer, a PLC, and a combination thereof, without limitation. According to some embodiments, the laterally-traversing washer mechanism may comprise first washing means, wherein the first washing means may comprise at least one spray bar (2). The at least one spray bar (2) may comprise a distal end and an open end, the open end preferably communicating with a manifold. The manifold may be able to rotate about an axis of the manifold to deploy the at least one spray bar (2) from a standby position (e.g., an “up” position and/or “horizontal” position) to a spraying position (e.g., a “rotated” position and/or a “vertical” position), without limitation. The manifold may comprise or communicate with a hose (22′), flexible pipe, or equivalent.

According to some embodiments, the laterally traversing washer mechanism may comprise means for shaking and/or vibrating at least one filter plate assembly and/or one or more filter cloths associated with the at least one filter plate assembly, without limitation. According to some embodiments, shaking and/or vibrating of at least one filter plate assembly may be induced by the travel (8) of the laterally traversing washer mechanism, without limitation (e.g., as suggested by the non-limiting embodiment shown in FIG. 13). According to some embodiments, the means for shaking or vibrating at least one filter plate assembly and/or one or more filter cloths may comprise one or more cam surfaces on one or more portions or surfaces of the at least one filter plate assembly, and one or more rollers for making contact with said one or more cam surfaces. Conversely, it is anticipated that one or more cam surfaces may be employed on a laterally-traversing washer mechanism, and one or more rollers and/or cam surfaces may be provided on one or more portions or surfaces of the at least one filter plate assembly, without limitation.

A filter (31, 38, 42) which may be provided with a frame (34) and washing means operatively coupled to the frame (34) may be provided. The washing means may be configured to wash one or more filter cloths simultaneously, as will be further disclosed and appreciated from the appended drawings. According to some embodiments, the filter cloths may be attached to a respective number of filter plate assemblies (13) which may also be supported by the frame (34). The washing means may comprise a laterally traversing washer mechanism; wherein the laterally traversing washer mechanism may be configured to move (8) along a lateral axis (35) of the filter (31, 38, 42); for example, from a first side (e.g., left-hand or right-hand side) of the one or more filter cloths to a second side (e.g., the other of said left-hand or right-hand side) of the one or more filter cloths, without limitation.

A method of filtering slurry is further disclosed. The method may comprise the steps of: providing a filter (31, 38, 42); moving (8) a laterally traversing washer mechanism in a direction along a lateral axis (35) of the filter (31, 38, 42); rotating at least one spray bar (2); and, providing wash water to the at least one spray bar (2), without limitation. The step of providing a filter may comprise providing a filter having a frame (34) and washing means operatively coupled to the frame (34). The provided filter may be configured to wash one or more filter cloths simultaneously. The one or more filter cloths to be washed may be attached to a respective number of filter plate assemblies which may also be supported by the frame (34). In some embodiments, the washing means may comprise a laterally-traversing washer mechanism, and the laterally traversing washer mechanism may be configured to move (8) along a lateral axis (35) of the filter (31, 38, 42) from a first side of the one or more filter cloths to a second side of the one or more filter cloths, without limitation. According to some embodiments, the laterally traversing washer mechanism may be provided with at least one spray bar (2).

Additional features and benefits will be apparent from the below description and appended drawings.

### BRIEF DESCRIPTION OF THE DRAWINGS

FIG. 1 shows one embodiment of a washer carriage throughout a range of motions. In the particular embodiment shown, a spray bar makes one left hand lateral pass, followed by a right hand lateral pass.

FIG. 2 shows a first motion configuration shown in FIG. 1.

FIGS. 3-8 show sequential subsequent motions of a washer carriage according to FIG. 1.

FIGS. 9-10 show a washer carriage on a filter press, and illustrates how the washer carriage has the ability to travel down a length of the filter to index one or more filter plate assemblies.

FIG. 11 illustrates how spray bars may travel, according to certain embodiments, for example, in a manner which clears sidebars of the frame of a filter press.

FIG. 12 suggests how in some embodiments, a washer mechanism, such as one or more pressure wash manifolds can accompany one or more shaker mechanisms on the same movable carriage.

FIG. 13 shows one non-limiting alternative embodiment wherein a washing mechanism of a filter press or a component thereof (e.g., a washing manifold and/or a number of spray bars) may be operatively attached or connected to a number of rollers or cam followers that could shake filter cloth assemblies during horizontal lateral translation, without limitation.

FIG. 14 shows one non-limiting embodiment of how rotary actuators may be used in order to rotate a spray bar or manifold, without limitation.

FIG. 15 shows how gravity, one or more spray bars, and one or more cam surfaces (or other equivalent kinematic device known in the art, such as a roller or track), may communicate, in order to rotate/pivot portions of a washer mechanism in a wash cycle, without limitation (e.g., in a first pass of a two-pass cycle).

FIGS. 16a-16d suggest a method of rotating and horizontally laterally translating a spray bar using gravity and more than one cam surface, according to some embodiments, wherein a single pass wash cycle may be made for a first filter plate assembly by moving the spray bar in a first direction, and wherein the spray bar may return in a second direction which is opposite the first direction for a second pass wash; or, the spray bar may be optionally indexed down the length of the filter to a different longitudinal position along the filter, to a second filter plate assembly (e.g., by virtue of a moveable washer carriage) and then moved in said second direction which is opposite the first direction, in order to wash the second filter plate assembly in a single pass (i.e., a single-pass alternating wash cycle arrangement).

FIG. 17 suggests simple ways of actuating both lateral horizontal translation and rotation, with as little as one or two actuators, according to some non-limiting embodiments.

FIG. 18 suggests that in some embodiments, instead of a plurality of swivels for articulation of water delivery means, a flexible hose (preferably with slack) may be employed, without limitation. Moreover, FIG. 18 suggests that in some embodiments, translation may be enabled by a driven belt or chain drive, without limitation.

FIG. 19 suggests that in some embodiments, a scissor arrangement of linkages may be employed to enable translation and/or rotation, without limitation.

FIG. 20 suggests that in some embodiments, translation and/or rotation can be achieved by means of one or more linkage arms, which may be driven in a number of conceivable ways, without limitation.

FIG. 21 suggests that in some embodiments, washing means may be operatively provided to a frame portion of a filter, or to a floor portion adjacent a filter) rather than on a movable washer carriage. FIG. 21 further suggests that it may be possible to configure a filter capable of washing all filter cloths of a filter simultaneously, without limitation.

FIG. 22 suggests that in some embodiments, washing means may be configured to wash only one filtration chamber of a filter, without limitation. For example, two filter cloths of opposing spaced filter plate assemblies may be washed, without limitation.

### DETAILED DESCRIPTION OF THE INVENTION

As described in related U.S. Provisional Patent Application Ser. No. 61/943,249 and International PCT Patent Application No. PCT/US2015/017117, a filter may comprise a frame supporting a track. The track may support a first carriage (e.g., a “washer” carriage comprising one or more washer mechanisms) which is movable relative to the track. The first carriage may comprise a frame having a wheel assembly which may be optionally damped with springs and/or dampers (e.g., pistons or shock absorbing apparatus), without limitation. The first carriage may comprise one or more “shaker mechanisms” for shaking one or more filter plate assemblies independently in quick succession, or simultaneously, without limitation. For example, one or more shaker cylinders may be operably connected to the frame of the first carriage. One or more shaker bars may be operably connected to the one or more shaker cylinders.

A first carriage cover may protect the one or more washer mechanisms and/or the one or more shaker mechanisms. The first carriage cover may, in some embodiments, protect an operator from moving components within the first carriage and/or may act as a “splash guard” to prevent wash water overspray to surrounding areas, without limitation. In some embodiments, the first carriage (e.g., “washer carriage”), may comprise first washing means, for example, a manifold, one or more spray bars communicating with the manifold, one or more washing nozzles communicating with the one or more spray bars, and/or one or more swivel joints, without limitation.

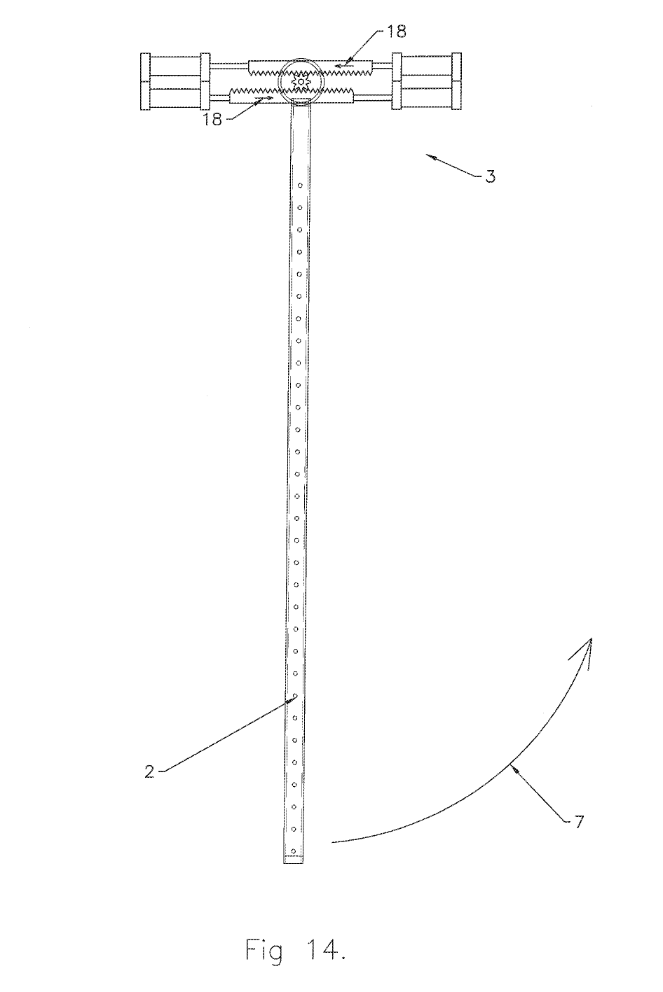

Rather than raising and/or lowering a spray bar or a plurality of spray bars vertically up and/or down between one or more filter plate assemblies to wash respective filter cloths as done with FLSmidth® Shriver® filter presses and as suggested in U.S. Provisional Patent Application Ser. No. 61/943,249 and International PCT Patent Application No. PCT/US2015/017117, a different kinematic motion for one or more spray bars may be employed as shown in the appended figures. For example, a rotary, lateral translation motion may be advantageously utilized so that a washer carriage may have a smaller size envelope, while still being capable of washing the square or rectangular shape of filter cloth faces needing washing. A spray bar or a plurality of spray bars connected to a manifold configured with one or more swivel joints and/or flexible tubing may exhibit a combination of rotation and translation motions. As will further be appreciated by the disclosure and appended drawings, the rotary and laterally-translating design may save space, construction materials, and may be more energy efficient than conventional washer designs. By combining rotary and horizontally laterally translating motions, mechanical complexity may be reduced, and less moving components may be necessary over conventional washer mechanisms. The low height washer carriage disclosed herein provides a lower center of gravity than prior devices and may demonstrate increased stability because it does not require significantly raising and lowering one or more spray bars like predecessor wash systems. Rather, one or more spray bars may “slide” via a horizontal lateral translational movement imparted by an actuator or equivalent means. Rotation (7) may be achieved via gravity and the weight of one or more spray bars, or a rotary actuator may be employed to rotate (7) the one or more spray bars as demonstrated in FIG. 14.

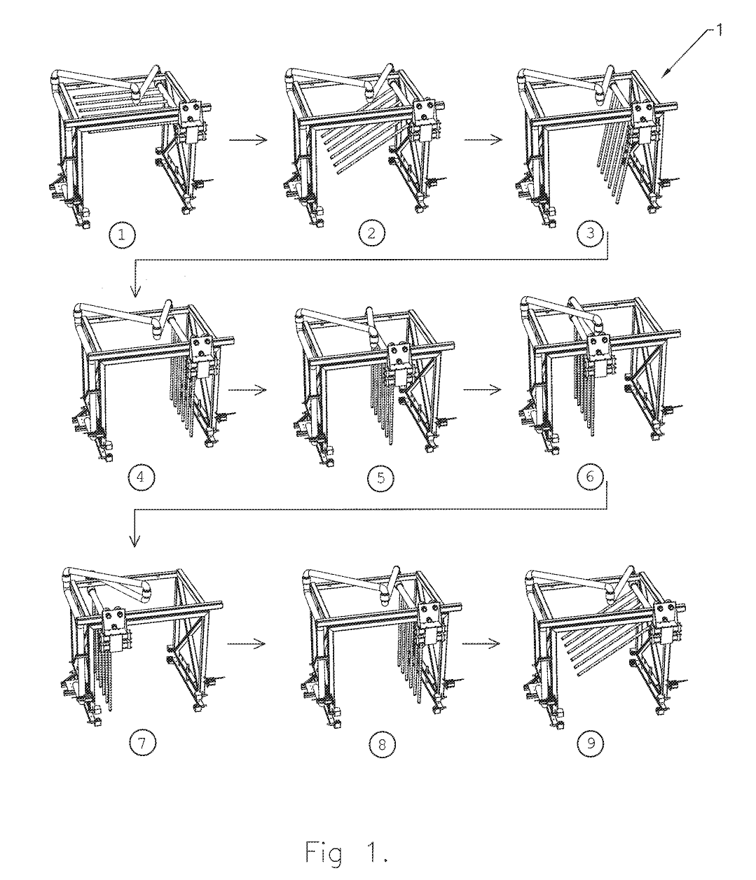

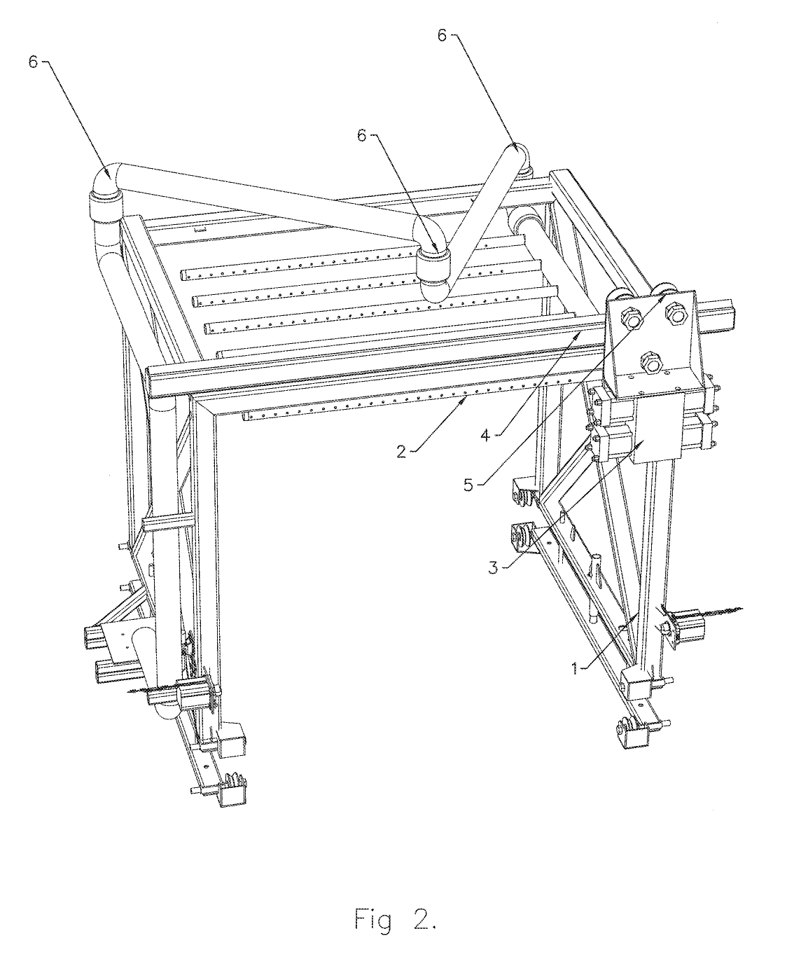

FIG. 1 shows one non-limiting embodiment of a laterally traversing washer mechanism operating through a range of motion. The laterally traversing washer mechanism may be floor-mounted, mounted to the frame of a filter (31) (e.g., a horizontal filter press comprising vertically-disposed, horizontally-stacked filter plates), or provided to a mobile washer carriage (1) as shown. The washer carriage (1) may be supported by and may ride along/on a track provided to the floor adjacent a filter (31). Preferably, as shown, the washer carriage may be supported by a track (33) which is mounted to one or more portions of a frame (34) of a filter (31). Washing means may be provided to the washer carriage (1) which is configured to wash one or more filter cloths simultaneously. For example, as shown, the washing means may comprise a number of spray bars (2) (e.g., a single spray bar or a plurality of spray bars) which start in an “up” position, as shown in FIG. 2, in order to clear the tops of the filter plate assemblies when the washer carriage (1) indexes to another group of plates or travels along its track (33) axially down a length of the filter (31) along a length axis (30).

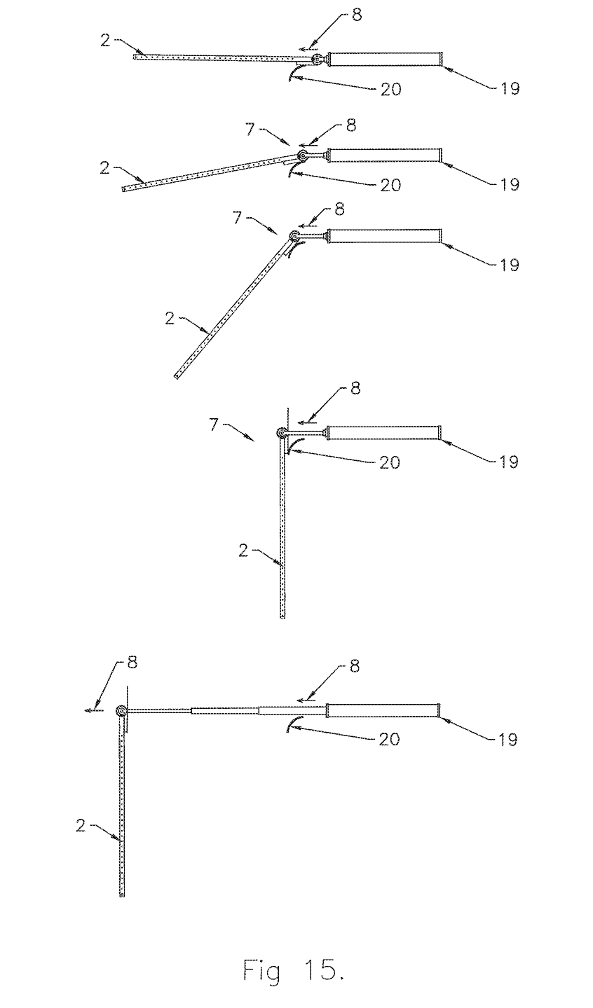

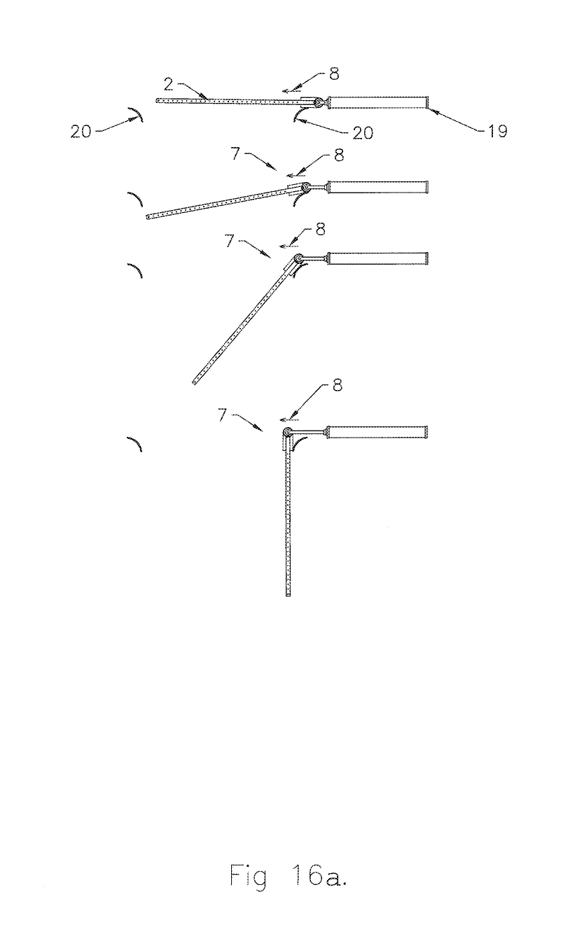

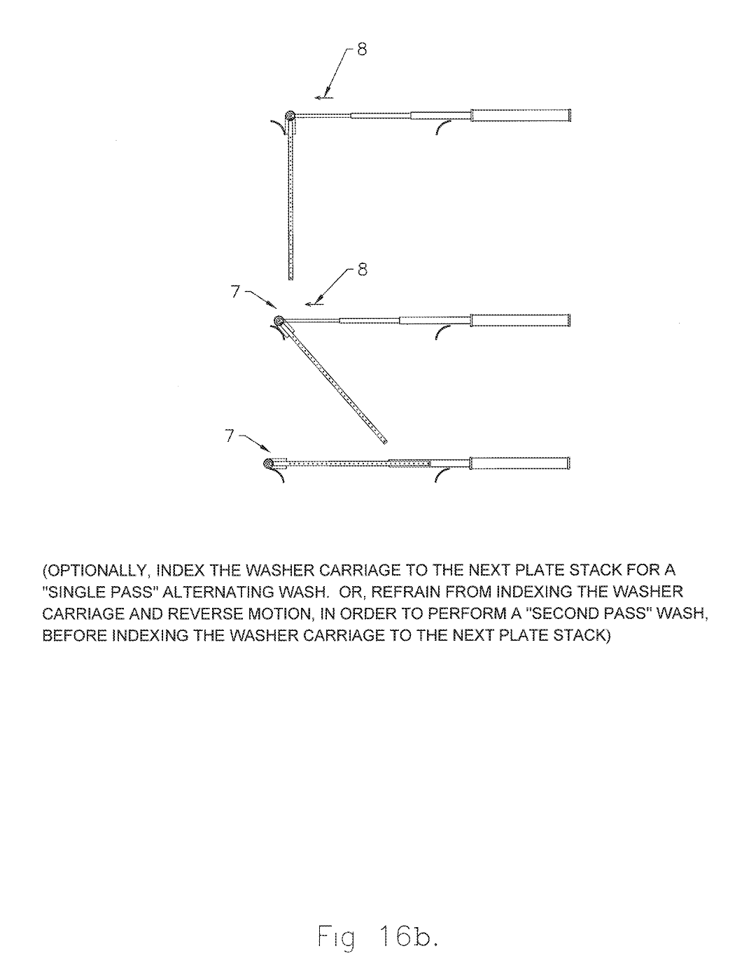

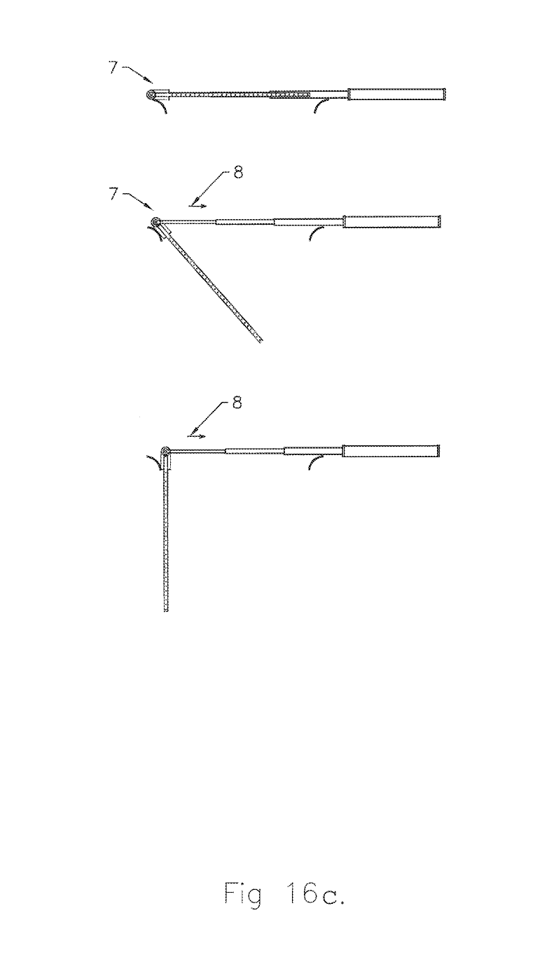

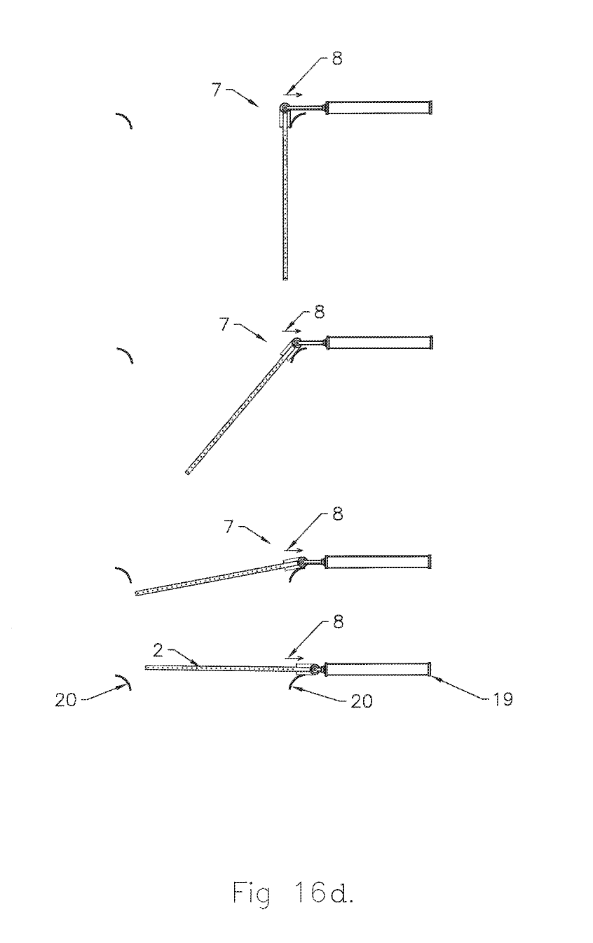

The washer carriage (1) may approach one or more openings between filter plate assemblies, and stop. Once stopped adjacent to one or more filter cloths to be washed, the one or more spray bars (2) may rotate, for example, via rotary means (3). Rotary means (3) may, in some embodiments, comprise a rotary actuator such as an actuator configured to rotate a manifold that is operatively connected to the one or more spray bars (2). The actuator may be motorized, for example, electronically, pneumatically, and/or hydraulically, without limitation. A reducer, reduction drive, gearbox, or the like, may, in some embodiments, be utilized and may form a portion of rotary means (3); or, the actuator may rotate the manifold and/or spray bar directly, without limitation. In some instances, the rotary means (3) may comprise an actuator, such as one or more linear actuators, as well as one or more pivot slide surfaces (20), wherein gravity and the weight of the one or more spray bars (20) may kinematically deploy the one or more spray bars as shown in FIGS. 15-16, thereby simplifying the washing means, without limitation. At any point during operation (e.g., preferably somewhere at, near, before, after, or during rotation of the one or more spray bars (2), wash water or cleaning fluid may turn on (or off), thereby commencing (or completing) a single-pass or multi-pass plate and/or cloth washing portion of a filtration cycle. The wash water or cleaning fluid may be pulsed on and off, or stay on during a wash cycle, without limitation.

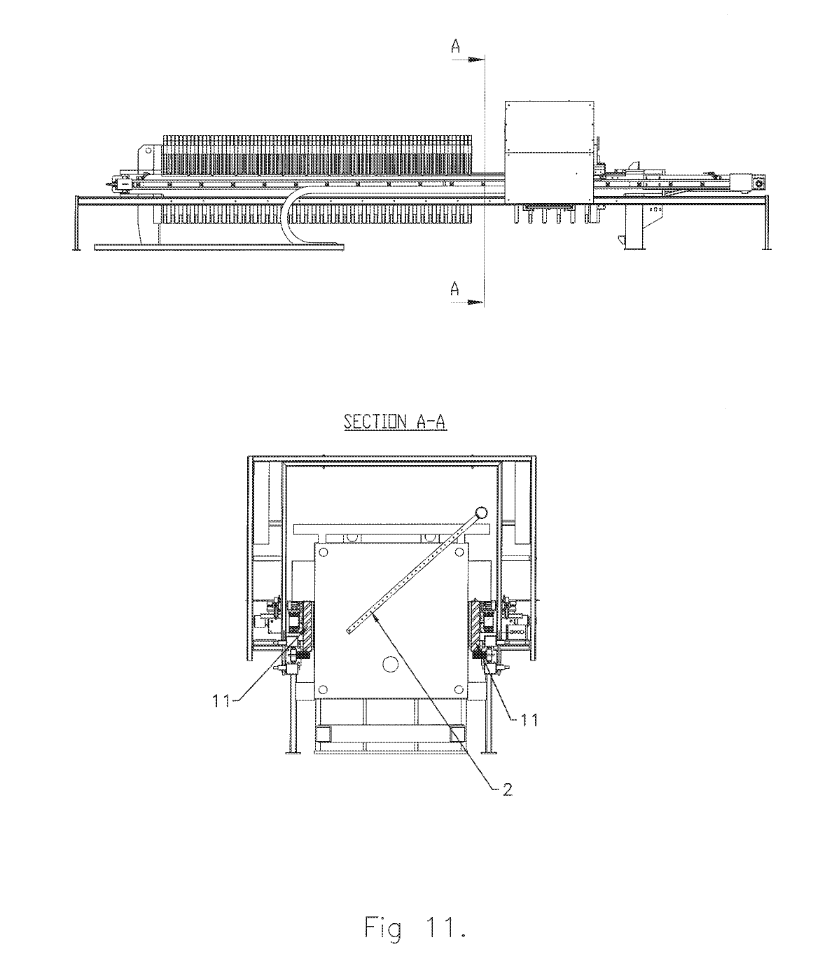

In some embodiments, after rotating to a certain point (e.g., to clear a sidebar (11) adjacent a first side of the one or more filter cloths as shown in FIG. 11), the one or more spray bars (2) may be in a third position, and the laterally traversing washer mechanism may laterally translate along a lateral axis (35) of the filter (31), a relatively small distance horizontally, in order to reduce the possibility of the spray bars (2) making contact with an opposing sidebar (11), without limitation. It should be understood that the one or more spray bars (2) may be formed in various geometric shapes, sizes, lengths, and nozzle spray patterns, and therefore, additional movements of the laterally traversing washer mechanism may not be necessary in all situations.

In an exemplary fourth position, the one or more spray bars (2) may be approximately fully deployed. For embodiments comprising straight spray bars(2), such as the particular embodiments depicted, the one or more spray bars (2) may be oriented approximately vertically, adjacent to a first side of the one or more filter cloths, and generally clear of side bars (11).

In exemplary fifth and sixth positions, the washing means may actively spray the filter plate assemblies and their respective one or more filter cloths, as the vertically-oriented or otherwise fully-deployed one or more spray bars (2) and manifold translate to a second side of the one or more filter cloths which is opposite of the first side of said one or more filter cloths. Preferably, the one or more spray bars are sized and shaped, and the motion of the laterally traversing washer mechanism is adapted to substantially or fully accommodate a complete washing of a square or rectangular surface area (e.g., of a square or rectangular filter plate assembly or filter cloth). However, it is anticipated that the wash mechanisms disclosed herein could be equally employed with filters comprising round or non-rectangularly shaped plates and cloths, without limitation.

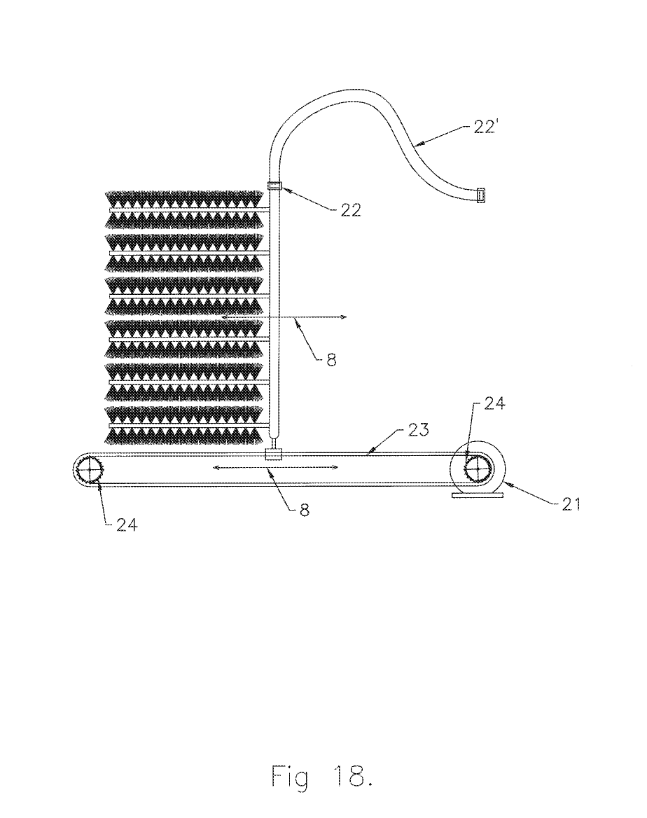

In an exemplary seventh position, the one or more spray bars may have reached the end of their path of travel in a first direction and may return back to position number 1 in a second direction. As will be discussed hereinafter, and as suggested by FIG. 16b, the one or more spray bars may continue to further positions, for example, for single-pass (“alternating”) wash embodiments. The wash water supplied to the spray bars (2) can remain on for the trip back, thereby effectively spaying the surfaces of the filter plate assemblies and/or the one or more filter cloths, twice. Of course, if increased cleaning is necessary, the laterally traversing washer mechanism could travel back and forth along lateral axis (35) one or more additional times, wherein overall wash cycle time may be governed by the rate of travel (8) of the one or more spray bars (2), or by the number of spray bar passes per cycle. In some embodiments, the rate of lateral travel of the one or more spray bars (2) could be decreased, thereby increasing the duration of washing time. Alternatively, in some embodiments, the pressures and/or flow rates of wash water to the one or more spray bars (2) could be increased or decreased in a manner consistent with what is necessary for providing enough flowrate or fluidic impact energy to remove the particles from the one or more filter cloths and filter plate assemblies, without limitation. After a wash cycle has been completed, the one or more spray bars (2) may be oriented in an exemplary eighth position, which may be similar to the aforementioned exemplary fourth position. In the exemplary eighth position, the one or more spray bars (2) may still be clear of the closest adjacent sidebar (11). Subsequently, the laterally traversing washer mechanism may rotate the one or more spray bars (2) and translate to exemplary position nine, wherein the wash water to the one or more spray bars (2) may be turned off or otherwise turn off shortly after or before exemplary position nine. Finally, the one or more spray bars (2) may return to the exemplary first or “up” position, wherein (depending on the size, shape, and configuration of the one or more spray bars (2)) the one or more spray bars (2) may be oriented generally horizontally or nearly horizontal and ready for the washer carriage (1) to travel to the next indexed position along a length axis (30) of the filter and wash more open plates. Although FIG. 1 shows a linkage comprising multiple tubes or pipes connected by swivel joints (6), it should be understood that a single flexible tube (22′) may be equally employed as suggested in FIGS. 18-20)

FIG. 2 shows a non-limiting example of a washer carriage (1) according to some embodiments, as well as its frame and components. The washer carriage (1) may comprise means for traveling down a length (e.g., the entire length) of the filter (31) and means for indexing the washer carriage (1) to various washing positions along the filter (31), without limitation. The washer carriage (1) may comprise washing means having a laterally traversing washer mechanism and one or more spray bars (2) operatively connected to the laterally traversing washer mechanism. For example, in the particular embodiment shown, a plurality of spray bars (2) may be operatively connected to the laterally traversing washer mechanism via a manifold and rotary means (3) comprising an actuator. The manifold may generally serve to connect and feed wash water to the plurality of spray bars (2). The manifold may, in some embodiments, comprise a number of swivel joints (6, 22), for example, single or multi-axial swivel joints, without limitation. In some embodiments, a flexible hose (22′) may be employed, preferably with at least one swivel joint (22). In some embodiments, a flexible hose (22′) may be provided directly to a manifold with no swivel joints (6, 22). Each of the one or more spray bars (2) may comprise one or more fluid orifices which may be oriented perpendicularly as shown, or which may be oriented tangentially or at any number or combination of different desired angles or combinations of angles, in order to effectively orient the spray jets of washing fluid leaving a spray bar (2) toward the face of the one or more filter plates and their respective filter cloths. Simple drilled orifices or more complex adjustable or directional nozzle structures (e.g., nozzles of the screw-in or weld-on type) may be employed, without limitation. The rotary means (3) may comprise one or more actuators which could be hydraulic in nature (as shown) or pneumatic in nature, without limitation. The rotary means (3) may comprise any unit or combination of units or devices that helps to induce controlled rotation of the one or more spray bars (for example, by rotating a manifold to the one or more spray bars (2) as shown), including electric motor devices, without limitation.

Traversing means (4), which may, in some embodiments, include a rail or linkage, or other mechanical member that assists with guiding the lateral translation of the washing means (e.g., in a direction of the lateral axis (35) of the filter (31) as shown), may be employed. By virtue of the traversing means (4), components of the laterally traversing washer mechanism such as the manifold, spray bar(s), nozzles, rotary means, or any combination thereof may be configured to move laterally (8) from a first side of the one or more filter cloths, to a second side of the one or more filter cloths, without limitation.

Rotation (5) may be used in conjunction with traversing means (4) to impart lateral horizontal movement of washing means (see top right of FIG. 2). Rotation (5) may be enabled, for instance, by a guide roller which contacts a complementary rail or track (4) as shown in the particular embodiments depicted. However, it should be appreciated that any item, assembly, or mechanical construction that is configured or would be suitably adapted to guide the horizontal translation (8) of washing means laterally from a first side of the one or more filter cloths to a second side of the one or more filter cloths, is anticipated.

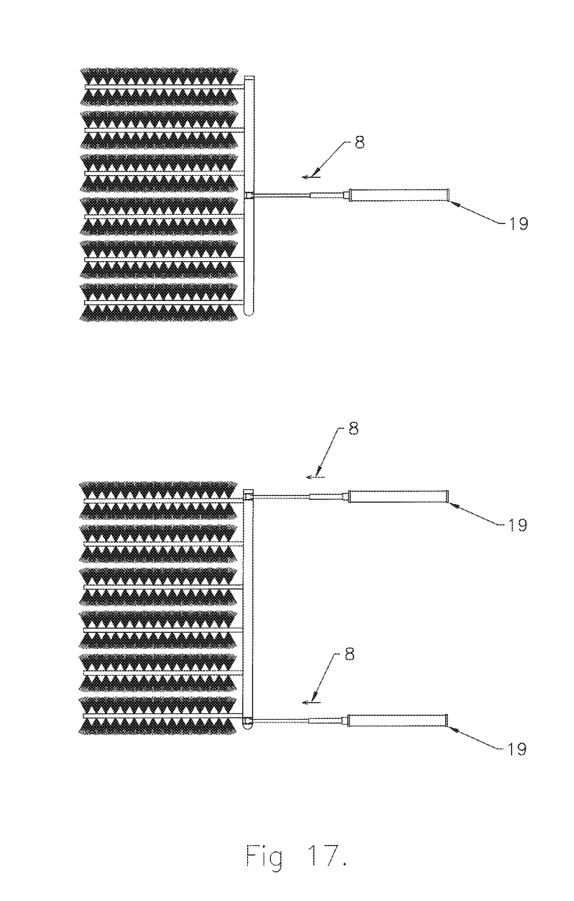

Not shown for clarity in FIGS. 1-8, is a driving mechanism that may be used to drive at least one of the guide rollers (5), in order to move the manifold and one or more spray bars (2) laterally from a first lateral side to a second lateral side of the washer. In some embodiments, one or more of the guide wheels (5) may be directly driven (e.g., by being coupled to a motor, drive shaft, and optional gear reducer). In some embodiments, one or more of the guide rollers (5) may be indirectly driven (e.g., via a separate driven wheel and friction acting between the separate driven wheel and one or more of the guide rollers (5)). In some embodiments, one or more of the guide rollers (5) may simply be “idler” or “roller” wheels for supporting and guiding the manifold and one or more sprayer bars (2), for example, v-shaped wheels configured to roll on a v-shaped rail or track (4), wherein the bracket securing the guide rollers (5) may be moved in a lateral direction (8) along a lateral axis (35) of the filter (31) via one or more actuators (19) such as linear actuators, cylinders, or other mechanisms (e.g., as suggested in FIGS. 17-20), without limitation.

A laterally traversing washer mechanism may travel or otherwise move (8) generally in a lateral axis (35) direction, for example, via a rack and pinion arrangement and/or via a chain and sprocket arrangement as suggested in FIG. 18. A motor may be used, for instance, to drive a chain in a lateral axis (35) direction (8) in a similar way as a chain drive may be used to move a shifter (40) in a direction along a length axis (30) of a filter (31, 38, 42). Various other drive means may be provided, and may include components such as belts (e.g., v-belts or toothed belts), idler or driven pulleys, or cables with sheaves that may be suitably adapted to pull, push, or otherwise cause a laterally translating motion (8) which moves the one or more spray bars (2) laterally between and across a width of one or more filter cloths. One or more rotary swivels (22) and/or fluid articulating means (6) may be employed as shown, in order to allow lateral translating motion (8) of components of the washing means (e.g., the laterally traversing washing mechanism comprising one or more spray bars (2) shown). The one or more rotary swivels (22) or fluid articulating means (6) may comprise, for example, components of the type often used in the oil and gas industry to allow large high pressure piping joins to swivel and transfer fluids. Some conceived, non-limiting embodiments which employ articulating rigid or flexible pipes or hoses which utilize multiple swivel joints (6, 22) are shown. Alternative means for allowing fluid articulation are available. For example, an alternative embodiment might include the use of a flexible hose, a hose in a hose track carrier, and/or a hose in combination with one or more retractable hose reels, without limitation, as well as other similar or equivalent means known in the art.

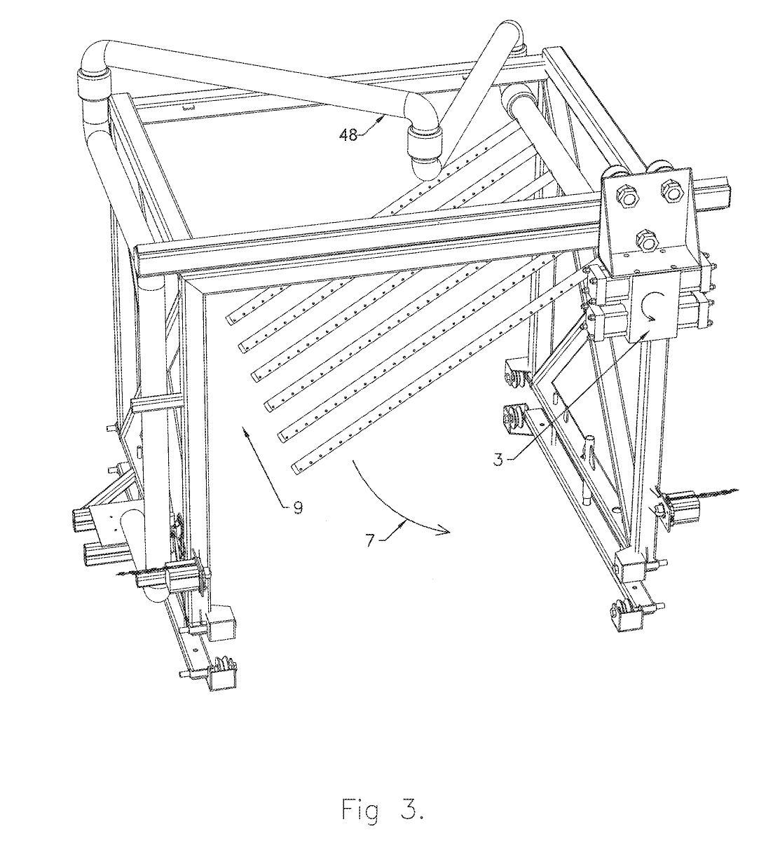

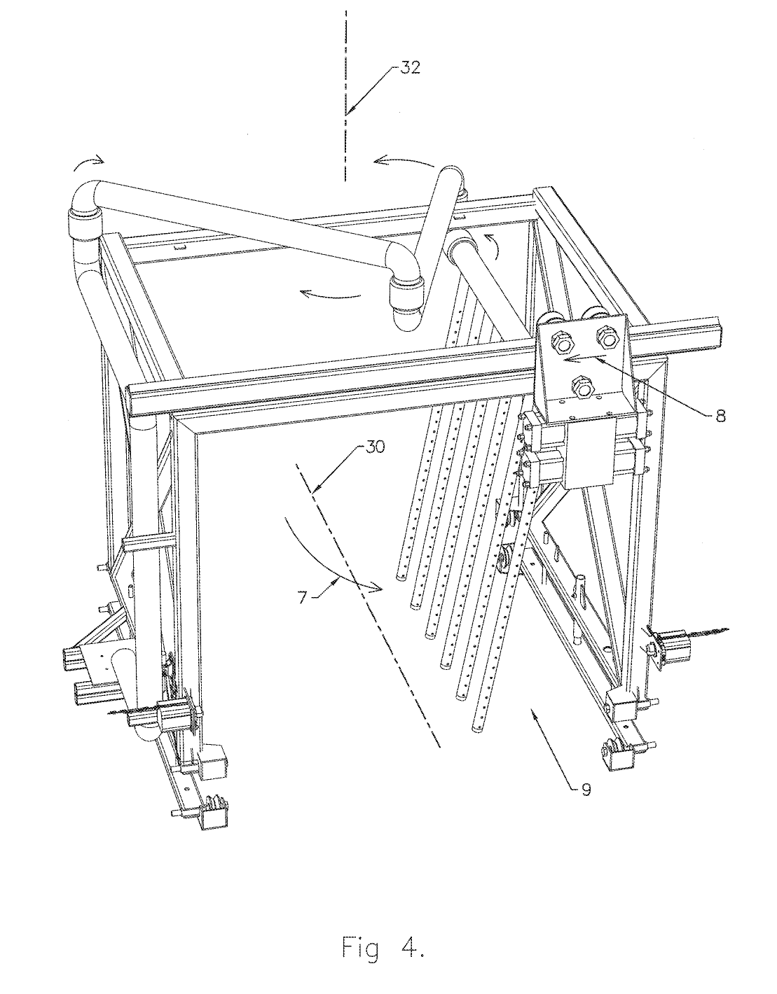

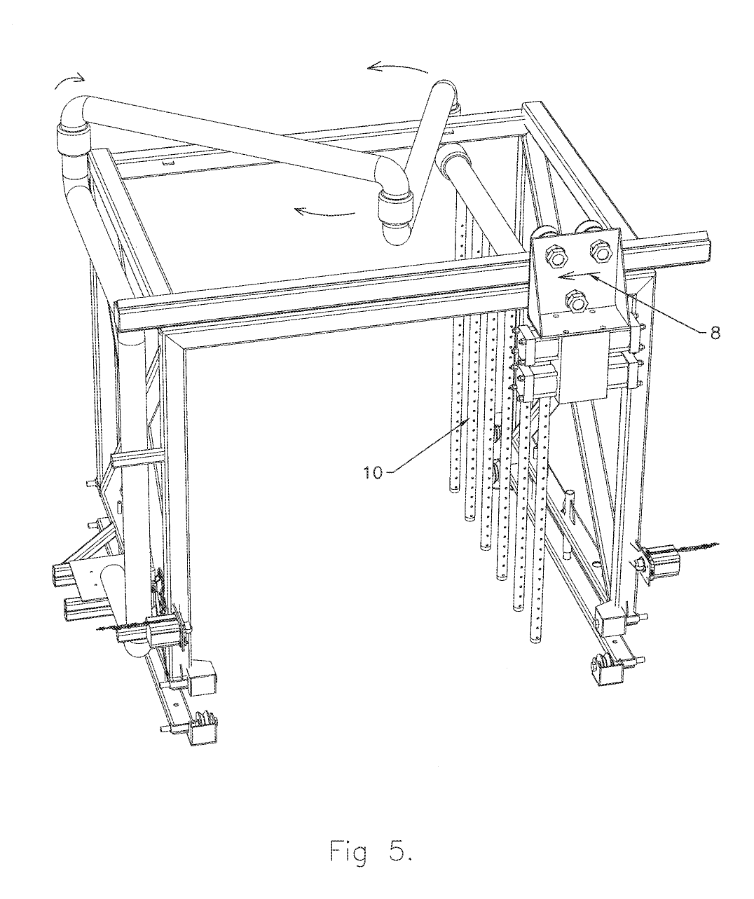

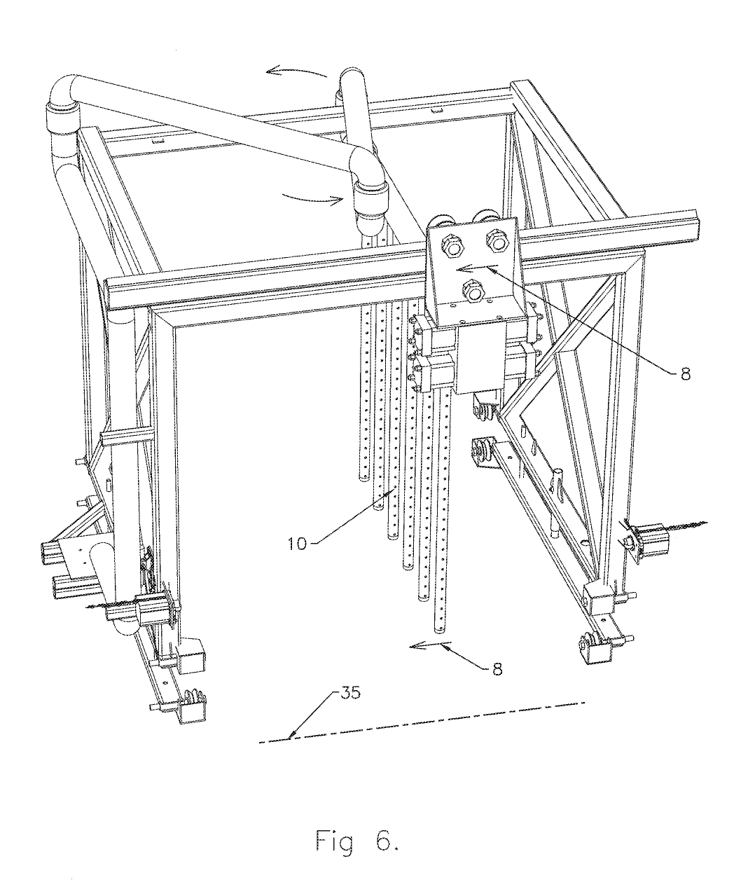

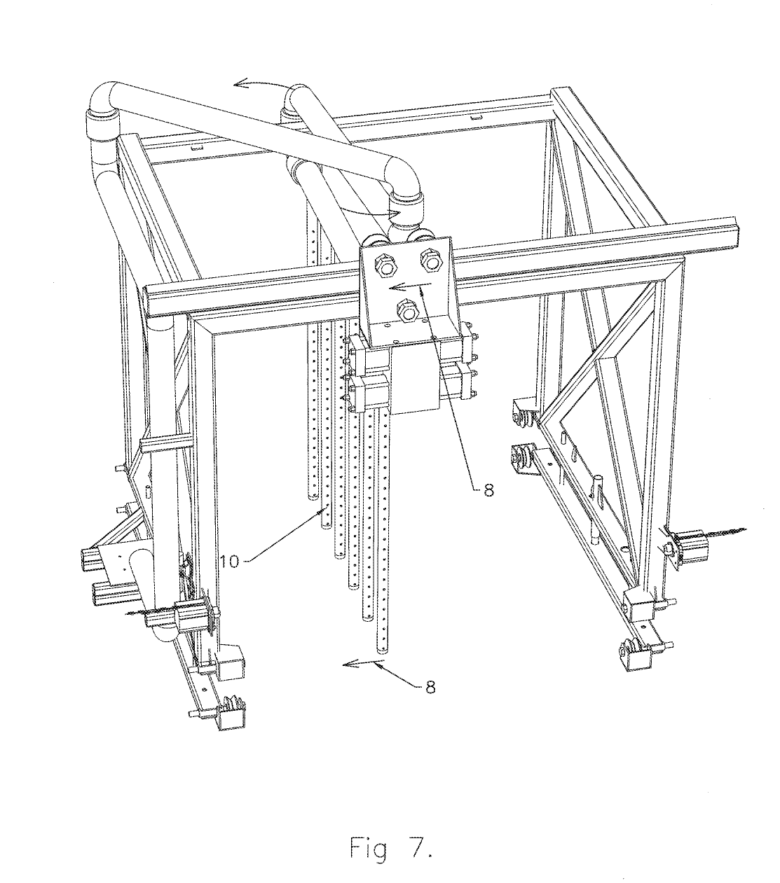

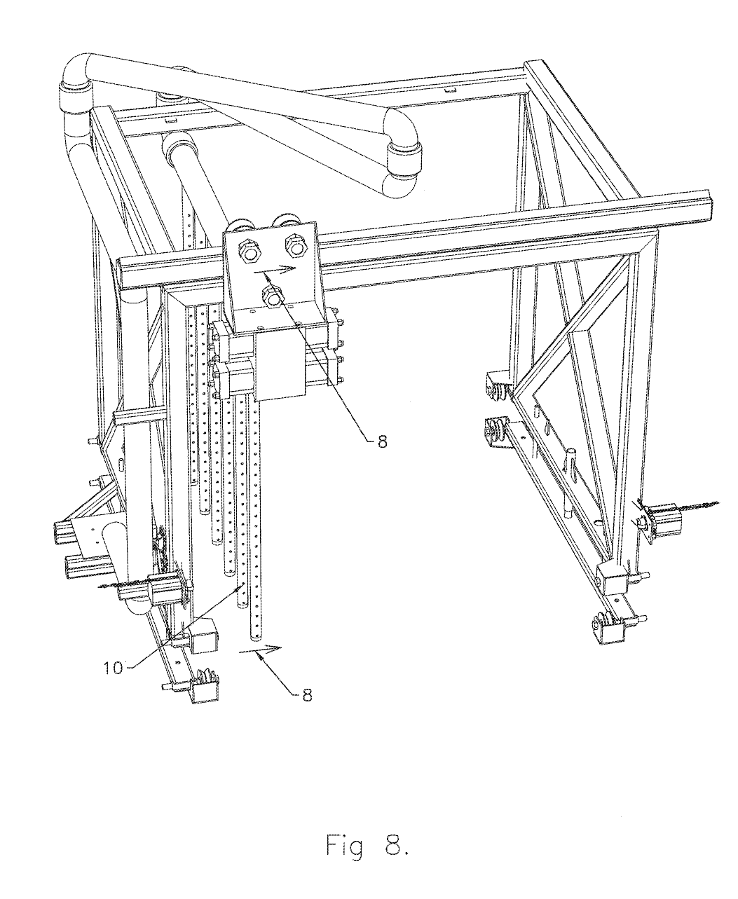

FIGS. 2-8 show in greater detail, the travel, motion, and/or articulation of an exemplary rotary laterally translating washer mechanism described in the description; wherein FIG. 2 corresponds to step 1 of FIG. 1; wherein FIG. 3 corresponds to step 2 of FIG. 1; wherein FIG. 4 corresponds to step 3 of FIG. 1; wherein FIG. 5 corresponds to step 4 of FIG. 1; wherein FIG. 6 corresponds to step 5 of FIG. 1; wherein FIG. 7 corresponds to step 6 of FIG. 1; and, wherein FIG. 8 corresponds to step 7 of FIG. 1.

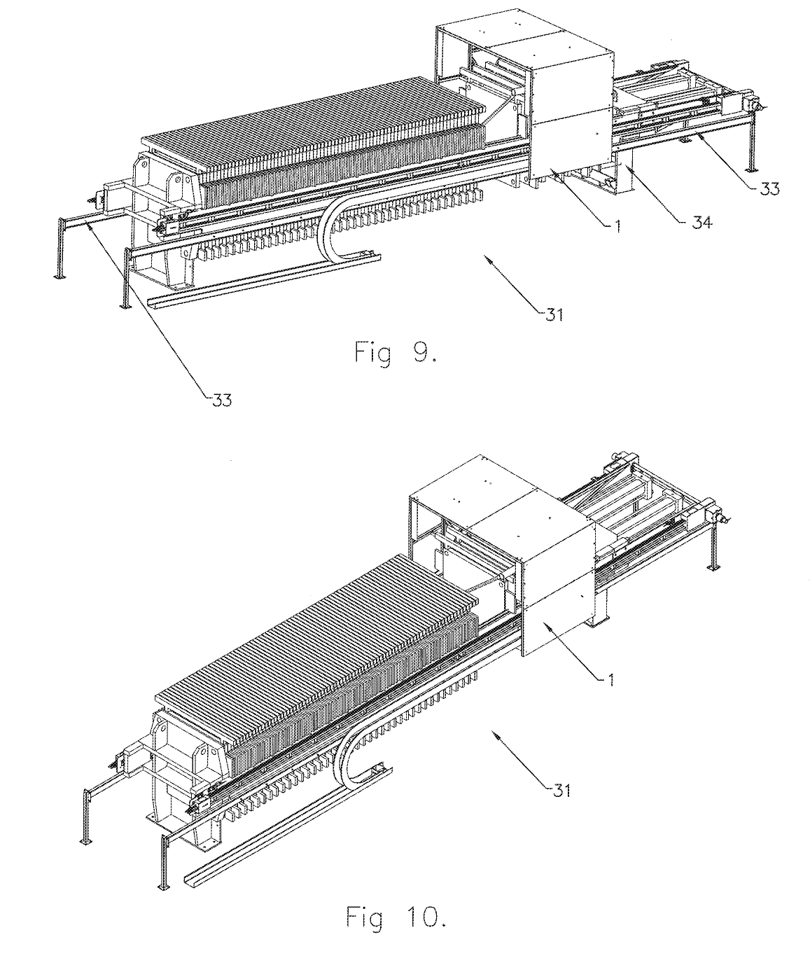

FIGS. 9-10 show a washer carriage (1) provided to a filter (31) and depict how the washer carriage (1) may be configured with the ability to travel down a length of the filter (e.g., along a length axis (30) of the filter, in order to index its position to various locations along the filter (31) to wash one or more filter plate assemblies (13) and one or more filter cloths associated therewith. Methods of moving and indexing a washer carriage (1), for example, using a shifter (40) are described in greater detail in related co-pending cases U.S. Provisional Patent Application Ser. No. 61/943,249 filed on 21 Feb. 2014, and International PCT Patent Application No. PCT/US2015/017117 filed on 23 Feb. 2014, which are hereby incorporated by reference in their entirety. The washer carriage (1) could comprise a lateral washing mechanism and plate/cloth shaker mechanism combined on one single (i.e., the same) carriage (1). Alternatively, the filter (31) may comprise a washer carriage (1) having a lateral washing mechanism alone. Alternatively, the filter (31) may comprise a washer carriage (1) having a lateral washing mechanism alone, and the filter (31) may further comprise a separate shaker carriage as described in the aforementioned copending U.S. Provisional Patent Application Ser. No. 61/943,249 and International PCT Patent Application No. PCT/US2015/017117.

FIG. 11 shows how it may be necessary for the one or more spray bars (2) to travel in a manner which clears the sidebars (11) of a filter press, when applicable. The use of both rotation (7) and lateral translation (8) of the spray bars (2) along axis (35) may facilitate washing filter plate assemblies, filter cloths, and/or filtering chambers, while still avoiding interference with sidebars (11).

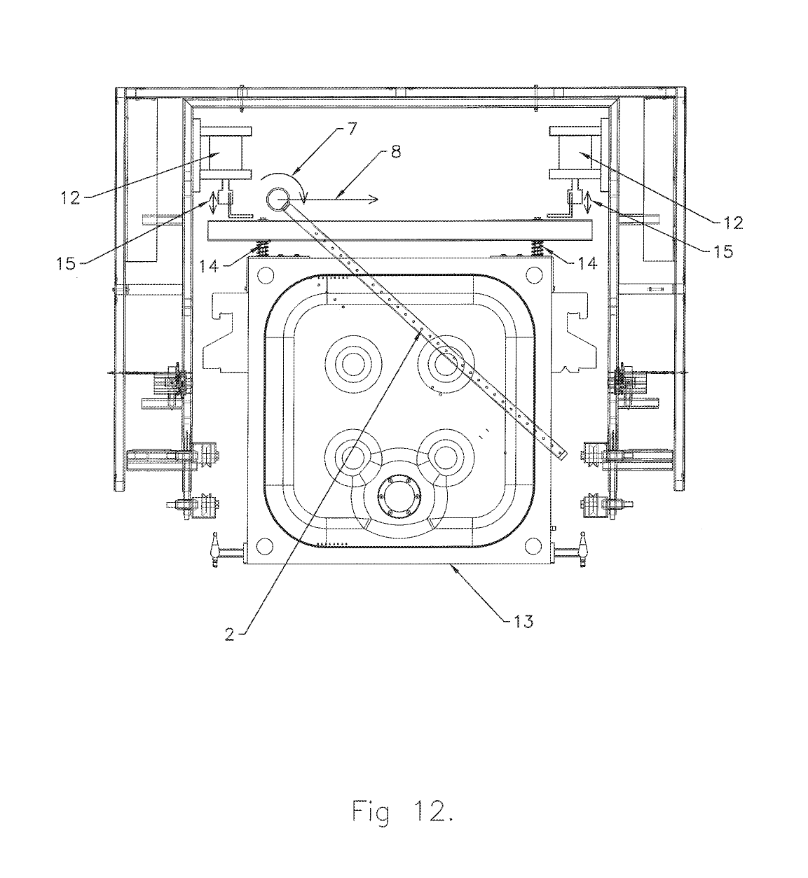

FIG. 12 shows how a pressure wash manifold and shaker mechanism share a carriage structure or carriage structures. For example, as shown, a washer carriage (1) may be configured with equipment which is configured to perform both the operations of shaking a number of filter cloths provided to plate assemblies within a filter (31) and washing filter cloths—preferably filter cloths which have been shaken. It should be understood that any combination of the two operations of shaking and washing are anticipated, such as the following scenario, without limitation:

I. the filter may open, without limitation;

II. a first group of plates may be opened with the shaker shaking each one of the first group of opened plates, without limitation;

III. the filter may then close the first group of opened plates and then open a second group of plates horizontally displaced from the first group of plates, without limitation;

IV. the washer may then index to the second group of opened plates, and index though each plate of the second group of opened plates, shake each one of the second group of plates, and then wash each filter cloth associated with the second group of opened plates, until all plates within the filter have been shaken and washed, without limitation.

If the particles do not wash off of the filter cloths well, then the cycle programming may be changed such that when the washer is washing a group of opened plates (e.g., a group of 6 opened plates), the washer may simultaneously shake the filter cloths during washing, without limitation. The act of shaking and washing simultaneously may increase the cleanability of one or more filter cloths, one or more filter plate assemblies, and/or one or more filtration chambers over a set duration of time. It will be understood and appreciated by those having an ordinary skill in the art, that the operational functions of washing and shaking could be performed together and/or separately.

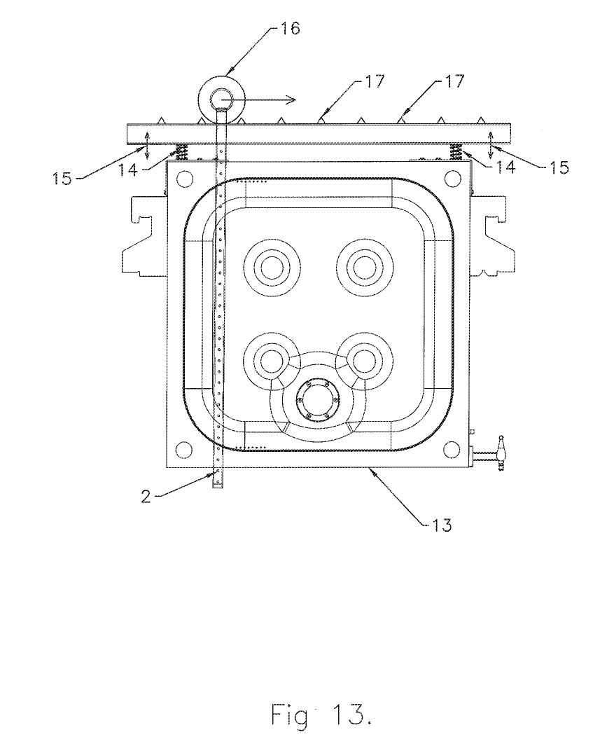

FIG. 13 shows an alternative embodiment where a washing manifold and/or one or more spray bars (2) may be operatively connected to, or otherwise attached to a set of one or more rollers (16). The rollers (16) may laterally translate (8) during movement of the washing means; for example, during washing the one or more filter cloths and/or the one or more filter plate assemblies (13). Simultaneous to the translation (8) of the laterally-traversing washer mechanism, the sideways movement of the set of one or more rollers (16) may impart shaking forces to the cloth bars, thus shaking (15) the filter cloths. In some embodiments, contact between the one or more rollers (16) and one or more ribs (17) provided to filter cloth hanging bars may result in vertical articulations (15) of one or more filter plates. For example, as shown, filter cloths may shake (15) as the set of one or more rollers (16) rolls over/passes by and makes interference with the one or more ribs (17).

FIG. 14 shows how rotary actuators may be used to impart rotational movement (7) to one or more spray bars (2) and/or a spray bar manifold, according to some embodiments. In the particular non-limiting embodiment shown in FIG. 4, a rotary actuator (3) may comprise a rack and pinion mechanism which may induce controlled rotation. One or more actuators, such as pneumatic or hydraulic cylinders may be used to move juxtaposed rack portions of the rack and pinion mechanism, which in turn, may rotate a pinion operatively coupled to a rotatable mount, to which a spray bar (2) may be secured. Though not explicitly shown, it is possible to use a single rack instead of the dual rack setup shown. It is also possible to utilize one or more long-stroke cylinders to perform both translation and/or induce rotation all in one unit (see FIGS. 15-17 and 19). Various uses of cams and/or levers could also induce the desired rotation (7)—for example, at a specific point in lateral translation (8) of the manifold and its one or more spray bars (2), without limitation. There may be many other ways to kinematically induce rotation (7) and/or translation (8) together or in sequence using various mechanical means which are configured to achieve such motions. The particular adaptation and use of rotation (7) and/or translation (8) for movement of a spray bar (2) to wash filter plate assemblies (13) and filter cloths associated therewith is new to the filtration industry, and the space savings for a high-performing washer may be considered to be a great improvement to and selling feature for high performance filter presses. It should be understood that while translation (8) and rotation (7) of spray bars (2) is preferred, rotation (7) only washer mechanisms are envisaged as alternative embodiments, wherein nozzles of spray bars (2) may be configured to reach all portions of filter cloths, the washing mechanism need not translate laterally (8) along a lateral axis (35), but rather only in a length axis (30).

FIG. 15 shows how gravity may be employed as rotary means (i.e., using the weight of the spray bars (2) to induce rotation (7)), and further demonstrates the use of one or more sliding surfaces (20) to control the rotary motion (7) of the one or more spray bars (2), without limitation. This figure also shows how utilizing a telescoping cylinder (19) could save space, for example, if a cylinder is used as the means for translation (8) and/or rotation (7).

FIGS. 16a-16b shows a method of rotating (7) and translating (8) and subsequently rotating (7) out of way, in a retracted or “up” position, when approaching the other side of a filter plate assembly (13) or filter cloth, in a lateral sense. This motion may be useful for “single pass” wash cycles, wherein a washer carriage (1) may index to another plate assembly (13) or stack of plate assemblies (13) before the sprayer bars(s) (2) returns to the home position shown at the top of FIG. 16a. By only sweeping across the face of the plate and cloths once (i.e., a “single pass”), it is possible to reduce the wash cycle time by approximately 50%, when compared to traveling laterally across a filter plate assembly (13) twice (i.e., a “double pass”) before returning to a home position before the washer carriage (1) indexes/moves down the filter along a length axis (30) direction of the filter (32, 38, 42) to another plate stack. A single pass wash may be a preferred embodiment for cloth washing methods simply due to the time savings and potential wash water savings. As suggested in FIGS. 16c-16d, there may be two different points in space, rather than a single point in space, about which rotation (7) occurs (e.g., occurring at two different sliding surfaces (20) laterally spaced apart along a lateral axis (35)). The direction of rotation (7) can be different through the range of motion as shown, depending on which point in space rotation (7) is occurring.

FIG. 17 suggests that in certain embodiments, actuation of the washing mechanism in both lateral translation (8) (e.g., in a direction along lateral axis (35)) and rotation (7) (e.g., about a longitudinal or length axis (30)) may be performed using only one means for actuation. In other words, all motion may be theoretically possible using a single actuator (19). For example, with one telescoping cylinder (19) alone, along with one or more sliding surfaces (20) and the aid of gravity and the weight of the one or more spray bars (2), the washing means (e.g., the rotary/laterally-translating washing mechanism shown) can translate and rotate through an entire range of motions shown in FIGS. 16a-16b, without limitation. Embodiments of washing means can also be designed to actuate translation and/or rotation using any permutation or combination of the one or more various means shown and described, without limitation. There are many anticipated mechanisms and methods in the industry which might equally induce similar translation (8) and/or rotation (7) motions, and any combination of these known equivalent means could advantageously provide a potential solution for moving the spray bars (2) and/or their manifold(s) to replicate the disclosed novel rotation (7) and translation (8) motions, without limitation.

FIG. 18 shows that instead or a plurality of swivels (6) and/or a number of pipes, tubes, or hoses extending between swivels (6) or similar fluid articulation means, rotations articulation (7) and lateral translating movement (8) of the wash water mechanisms may rely on a flexible hose item (22′) as a suitable fluid articulation means. In some embodiments, the hose (22′) may have one or multiple swivel end fittings (22), which might allow for rotation of the connection. A swivel item (22), such as an independent hydraulic swivel connector, may be provided, such that a hose (22′) may attach to a manifold supporting one or more spray bars (2). In the particular embodiment shown, a motor (21) may be provided. The motor (21) may comprise a motor that could be hydraulic, electrical, pneumatic, or which may comprise any type of motor known in the industry, without limitation. A sprocket (24) may be driven by the motor (21) in order to drive a chain (23). The motion of the chain (23) may drive lateral translation motion (8) of the spray manifold and/or one or more spray bars (2). The translation can also drive rotation (7) of the manifold and/or one or more spray bars (2), or, rotation of the manifold and/or one or more spray bars (2) can be a separate function performed by another actuator like a hydraulic, pneumatic, or electrical rotary actuator (as suggested by FIG. 14). In some embodiments, a sprocket (24) may act as a tensioning mechanism, for example, to keep the chain (23) tight during use. It should be understood that belt, pulleys, toothed belts, toothed pulleys, grooved belts, grooved pulleys, and the like are equally envisaged, and could be used in place of the depicted chain (23) and sprocket (24), without limitation.

In some alternate embodiments, the chain (23) could be mounted stationary to a structure, such as a filter frame (34) or washer carriage (1) and act as a rack, wherein a driven toothed pinion driven by a motor could act as a pinion causing the translating (8) motion of the manifold. For example, in such an embodiment, the manifold may be configured to move with the driven toothed pinion and translate laterally (8) to the desired position relative to the washer carriage (1), without limitation. Similar movement may be accomplished with a standard linear drive and/or rack and pinion arrangement, without limitation.

Lateral translation (1) of washing means comprising a washer mechanism could also be done, for example, with a long threaded drive rod or worm and follower mechanism, in order to induce translation (8). For example, it is common with large lathes and other items that require accurate translation to move via the rotation of an acme thread or screw drive mechanism. This screw drive mechanism would be an acceptable alternative way of inducing lateral translation (8) and/or rotation (7) but may not be considered a preferred method due to speed considerations (e.g., in instances where wash cycles are preferred to be completed quickly).

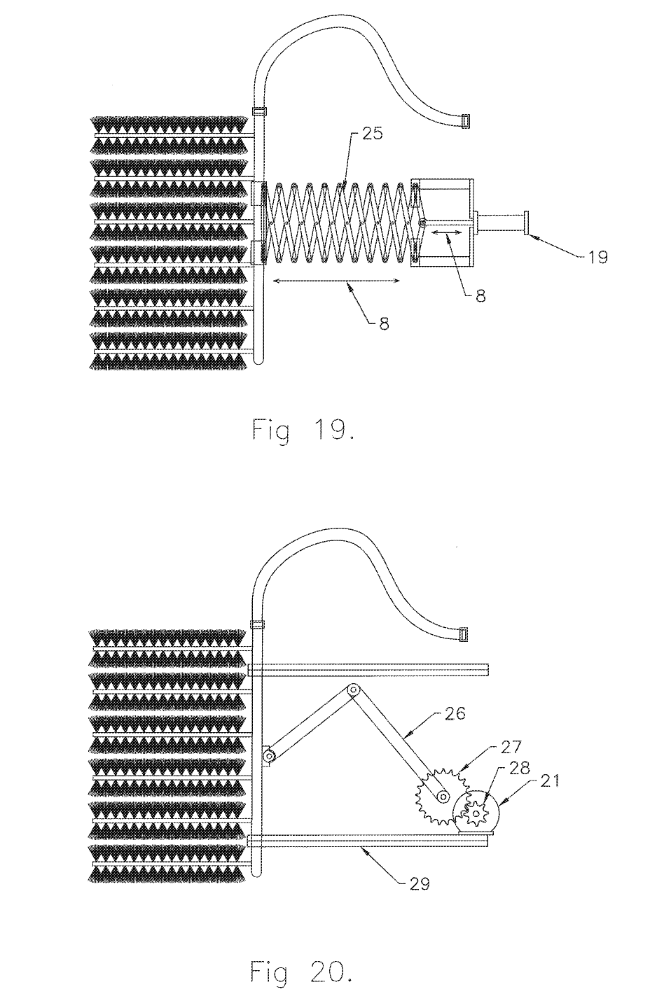

FIG. 19 shows a top view of a filter wash mechanism which may comprise a scissor arrangement of linkages (25). Linkages (25) may allow for a shorter stroke cylinder (19) to drive a washer mechanism to move (8) long travel distances in a lateral direction, for example, along lateral axis (35). As the cylinder item (19) retracts, the scissor mechanism shown may extend and move the manifold and one or more sprayer bars (2) much farther than would the short stroke of the cylinder (19) alone. Obviously, the linkage (25) may be designed such that an endpoint of the linkage remains stationary, and the cylinder (19) pulls/pushes in such a manner that translative motions (8) could be achieved by extending, rather than retracting, a rod of the cylinder (19). It is anticipated that the actuator (19), while shown to be a cylinder, could be any linear actuator capable of pulling or pushing a scissor linkage (25). A cable and rotating actuator may instead be used in conjunction with a counteracting leaf spring instead of a scissor linkage to accomplish similar motion, without limitation.

FIG. 20 shows that translation (8) and or rotation (7) can be achieved by means of one or more linkage arms (26), which may be driven. For example, the use of gears (27, 28) may be used to impart motion to the one or more linkage arms (26). The gears (27, 28) could be of differing sizes, for example to provide a reduction or to change the speed or torque applied to the one or more linkage arms (26). A drive motor (21) may be provided, wherein the drive motor (21) could be hydraulic, electrical, pneumatic or other type common in the industry. In some embodiments, the lateral travel (8) of the manifold could be guided by a guide rail (29), a linear guide, a groove, a recess, a track, or other guiding means typical to the industry, without limitation.

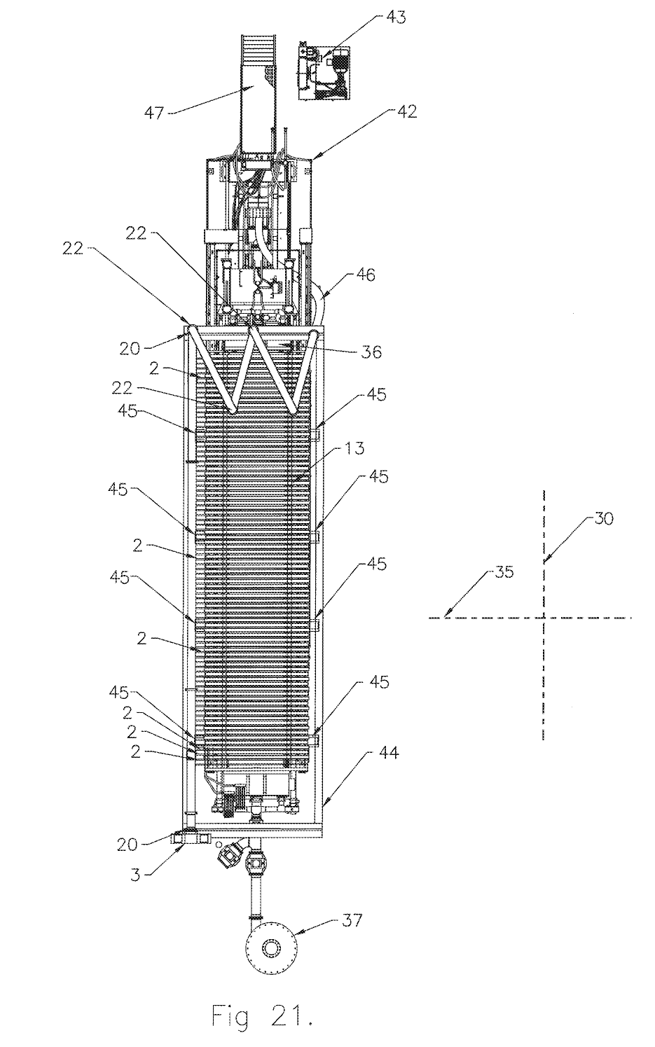

FIG. 21 shows a top plan view of an exemplary embodiment of a filter press (42), such as an FLSmidth® AFP automatic filter press, without limitation, which may not utilize a washer carriage (1), but instead, may use washing means comprising a manifold extending the entire length of the filter press (42). As shown, the manifold may connect a large number of spray bars (2) close to the number of plates in the filter press (42). The manifold may be rotated via rotary means (3) (left side of FIG. 21), and/or one or more optional pivot slide surfaces (20). The washing means may move laterally (e.g., from the left hand side of the figure, to the right hand side of the figure laterally across the entire length of the filter) to wash each and every filter plate assembly (13) simultaneously, for example, when the filter (42) is opened and all or some of the filter plate assemblies (13) are spaced from one another, without limitation.

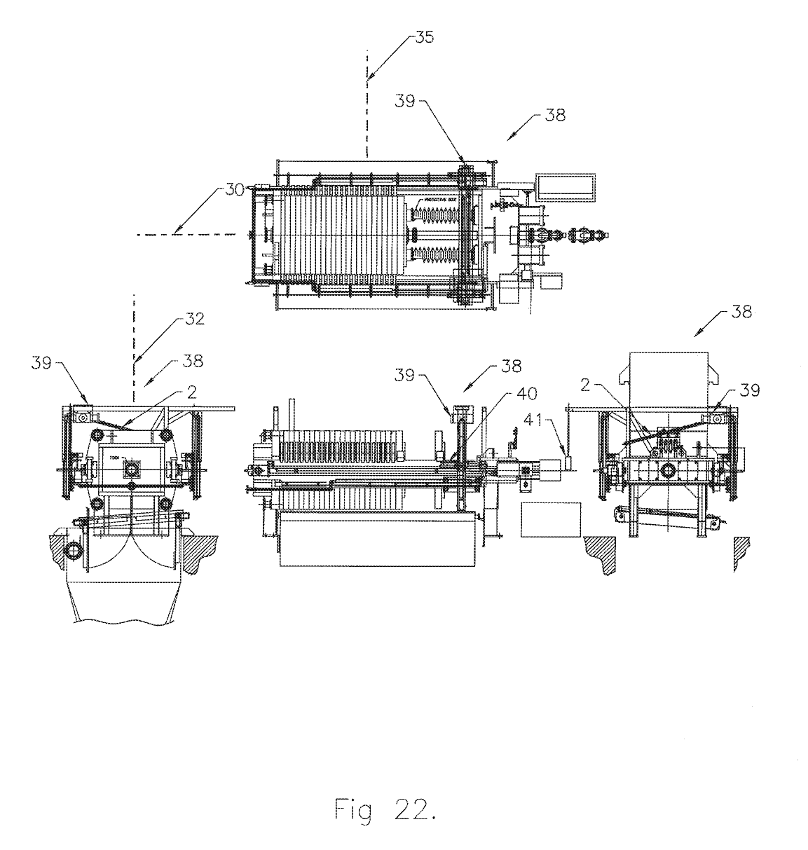

FIG. 22 shows a top plan view, two end views, and a side/lateral plan view of an exemplary embodiment of a filter press (38), such as an FLSmidth® Shriver® filter press, without limitation, which may utilize a washer carriage (1), but rather than washing a plurality of filter cloths provided to a plurality of respective filter plate assemblies (13), the filter press (38) may use washing means comprising a single spray bar (2) configuration of a rotary laterally-traversing washer (39). The rotary laterally-traversing washer (39) may be comprised of a small manifold connected to a single spray bar (2) which may be rotated (7) via rotary means (3) and/or one or more optional pivot slide surfaces (20) (not labeled in FIG. 22). The washing means may move laterally (8) (e.g., from one lateral side of the filter press (38) to the opposite lateral side of the filter press (38)), in order to wash each and every filter chamber/plate/filter cloth separately, as each filtration chamber within the filter (38) is opened in sequence, without limitation. A shifter (40) may be used to move a washer carriage (1) supporting the single spray bar (2) rotary laterally-traversing washer (39), without limitation.

A contractor or other entity may provide a system having a filter press or washer carriage in part or in whole as shown and described. A contractor or other entity may provide a filter press in part or in whole as shown and described. For instance, the contractor may receive a bid request for a project related to designing a filter press system or process, or the contractor may offer to design such a system or a process for a client. The contractor may then provide, for example, any one or more of the devices or features thereof shown and/or described in the embodiments discussed above. The contractor may provide such devices by selling those devices or by offering to sell those devices. The contractor may provide various embodiments that are sized, shaped, and/or otherwise configured to meet the design criteria of a particular client or customer or work advantageously with a particular filtration system or filter press. The contractor may subcontract the fabrication, delivery, sale, or installation of one or more components of a filtration system, filter press, washer carriage(s), or of other devices used to provide such one or more components. The contractor may also survey a site and design or designate one or more storage areas for stacking the material used to manufacture the systems discussed herein. The contractor may also maintain, modify, or upgrade one or more provided or existing filter presses, washer carriages, and/or components thereof. The contractor may provide such maintenance or modifications by subcontracting such services or by directly providing those services or components needed for said maintenance or modifications. In some cases, the contractor may modify an existing filter press or existing washer mechanism with a “retrofit kit” to arrive at a modified filter, washer carriage substantially as shown and described. Moreover, the contractor may sell, offer to sell, or provide a filtration process, a filter, a washer carriage, or a component of a washing mechanism having one or more of the process steps, devices, components, or technical features discussed herein.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

### REFERENCE NUMERAL IDENTIFIERS

The following reference numeral identifiers are provided for convenience with reference to the appended drawings, and are in no way intended to limit the scope of what is described and/or shown:
1 Washer carriage
2 Spray bar (e.g., in the “up” position in FIG. 2, in the “rotating” position in FIGS. 3 & 4, and in the “translating” position in FIGS. 5-8)
3 Rotary means (e.g., hydraulic rotary actuator with dual rack and pinion)
4 Traversing means (e.g., rail and roller guide system, chain drive, rack and pinion drive, overhead lift beam track)
5 Supporting means (e.g., V-shaped guide rollers on a rail, low friction slide blocks, linear slider bushing)
6 Fluid transfer articulating means (e.g., articulating pipe swivels, carrier track holding the hoses through range of motion, one or more swivel joints)
7 Rotation (e.g., of sprayer bar 2)
8 Translation (e.g., direction of lateral movement along a lateral axis 35)
9 Clearance
10 Translating spray bar 2 (e.g., for high pressure, low-pressure, or flood washing filter cloths)
11 Sidebar of the skeleton frame to clear
12 Shaker cylinder
13 Filter plate assembly (or one or ore components thereof)
14 Cloth shaking spring
15 Shaker bar vertical motion
16 Roller
17 Rib
18 Rack and pinion translation
19 Actuator (e.g., linear actuator, telescoping cylinder, long stroke cylinder)
20 Pivot slide surface (e.g., cam surface(s), polymer blocks, rollers, or bearing surfaces attached to frame portion of washer carriage)
21 Motor (e.g., hydraulic, pneumatic, electrical)
22 Swivel (e.g., hose end swivel or pipe swivel that pipe or hose connects to)
22′ Hose
23 Chain drive (e.g., chain and sprocket, belt and roller, cable and pulley)
24 Sprocket (e.g., a chain sprocket, a roller, a pulley, or sheave)
25 Scissor mechanism (e.g., arms in a scissor linkage arrangement)
26 Linkage arm
27 Gear (e.g., sprocket or sheave with an additional chain or belt)
28 Gear (e.g., sprocket or sheave with an additional chain or belt)
29 Guide means (e.g., to keep the washer translating, such as a beam, a linear guide, or rail)
30 Length axis of filter
31 Filter
32 Vertical axis of filter
33 Track
34 Frame
35 Lateral axis of filter
36 Moving crosshead
37 Core separation tank
38 Side bar filter press with rotary laterally traversing wash (e.g., FLSmidth® Shriver® filter press or other overhead filter press, “FBOH”)
39 Single bar rotary traversing washer
40 Shifter
41 Pendant control
42 Automatic filter press (e.g., FLSmidth® AFP® filter shown spread with open plate assemblies)
43 Hydraulic power unit (HPU) (e.g., to supply fluid power for hydraulic components)
44 Washer stationary frame structure
45 Floor pads and/or legs (e.g., to hold up the washer stationary frame structure)
46 Washer fluid supply hose
47 Carrier track for slurry hose
48 Hose, pipe

1-42. (canceled)

43. A filter having a frame supporting a track, and a washer carriage on the track which is configured to wash one or more filter cloths simultaneously, the filter cloths being attached to a respective number of filter plate assemblies which are supported by the frame, the washer carriage comprising a laterally traversing washer mechanism, the laterally traversing washer mechanism being configured to move along a lateral axis of the filter from a first side of the one or more filter cloths to a second side of the one or more filter cloths during a first single pass wash cycle, the laterally traversing washer mechanism being further configured to move along a lateral axis of the filter from the second side of the one or more filter cloths to the first side of the one or more filter cloths during a second single pass wash cycle; wherein the laterally traversing washer mechanism further comprises washing means; wherein the washing means comprises at least one spray bar which is configured to pivot about a length axis of the filter, via an actuator;
wherein the angular direction of pivot of the at least one spray bar about the length axis of the filter changes after the washer carriage indexes to a different position along the length axis of the filter;
wherein during the first single pass wash cycle, the at least one spray bar rotates or pivots in only a first angular direction of pivot as the laterally traversing washer mechanism moves along a lateral axis of the filter from the first side of the one or more filter cloths to the second side of the one or more filter cloths, during the during single pass wash cycle;
wherein after the first single pass wash cycle, the washer carriage indexes to a different position along the length axis of the filter;
wherein after the washer carriage indexes to a different position along the length axis of the filter, the at least one spray bar rotates or pivots in only a second angular direction of pivot as the laterally traversing washer mechanism moves along a lateral axis of the filter from the second side of the one or more filter cloths to the first side of the one or more filter cloths, during the second single pass wash cycle;
wherein the first single pass wash cycle cleans a first number of filter cloths;
wherein the second single pass wash cycle cleans a second number of filter cloths;
wherein the first number of filter cloths excludes the second number of filter cloths and the second number of filter cloths excludes the first number of filter cloths; and
wherein the second angular direction of pivot s opposite the first angular direction of pivot.

44. The filter according to claim 43, wherein the first single pass wash cycle reduces wash cycle time by approximately 50%, when compared to a double pass wash cycle.

45. The filter according to claim 44, wherein said first single pass wash cycle consists of the at least one spray bar moving along a lateral axis of the filter from the first side of the one or more filter cloths to the second side of the one or more filter cloths, before the washer carriage indexes to a different position along the length axis of the filter; and wherein said double pass wash cycle is consists of the at least one spray bar moving along a lateral axis of the filter from the first side of the one or more filter cloths to the second side of the one or more filter cloths, and then back to the first side of the one or more filter cloths from the second side of the one or more filter cloths, before the washer carriage indexes to a different position along the length axis of the filter.

46. The filter according to claim 44, wherein one or more swivel joints which are configured to pivot about a vertical axis of the filter, facilitates the move from a first side of the one or more filter cloths to a second side of the one or more filter cloths.

47. The filter according to claim 46, wherein the one or more swivel joints comprise at least one hose fitting.

48. The filter according to claim 47, wherein the laterally traversing washer mechanism comprises means for shaking or vibrating at least one filter plate assembly.

49. The filter according to claim 48, wherein the means for shaking or vibrating at least one filter plate assembly is induced by the travel of the laterally traversing washer mechanism.

50. The filter according to claim 48, wherein the means for shaking or vibrating at least one filter plate assembly (13) comprises one or more cam surfaces on at least one filter plate assembly (13), and one or more rollers for making contact with said one or more cam surfaces.

51. A method of filtering slurry using the filter of claim 43, comprising:
performing a first single pass wash cycle comprising:
pivoting the at least one spray bar in substantially a first angular direction of pivot about the length axis of the filter adjacent the first side of the one or more filter cloths;
providing wash water to the at least one spray bar;
moving the laterally traversing washer mechanism in a first direction along a lateral axis of the filter, and from the first side of the one or more filter cloths to a second side of the one or more filter cloths;
pivoting the at least one spray bar in substantially the first angular direction of pivot about the length axis of the filter adjacent the second side of the one or more filter cloths;
indexing the washer carriage to a different position along the length axis of the filter; and,
performing a second single pass wash cycle comprising:
pivoting the at least one spray bar in substantially a second angular direction of pivot about the length axis of the filter adjacent the second side of the one or more filter cloths; wherein the second angular direction of pivot is opposite said first angular direction of pivot;
providing wash water to the at least one spray bar;
moving the laterally traversing washer mechanism in a second direction along a lateral axis of the filter, and from the second side of the one or more filter cloths to the first side of the one or more filter cloths; wherein the second direction along a lateral axis of the filter is opposite said first direction along a lateral axis of the filter;
pivoting the at least one spray bar in substantially the second angular direction of pivot about the length axis of the filter adjacent the second side of the one or more filter cloths.
